(19) United States
(12) Patent Application Publication
(10) Pub. No.: US 2006/0232848 A1
(43) Pub. Date: Oct. 19, 2006

(54) Colorless Differential Phase Shift Keyed and Low Crosstalk Demodulators

(75) Inventors: Lei Xu, Princeton, NJ (US); Ting Wang, Princeton, NJ (US); Philip Nan Ji, Princeton, NJ (US); Lei Zong, Princeton, NJ (US); Milorad Cvijetic, Herndon, VA (US)

Correspondence Address: NEC LABORATORIES AMERICA, INC., 4 INDEPENDENCE WAY, PRINCETON, NJ, 08540, US

(73) Assignee: NEC LABORATORIES AMERICA, INC., Princeton, NJ (US)

(21) Appl. No.: 11/279,767

(22) Filed: Apr. 14, 2006

Related U.S. Application Data
(60) Provisional application No. 60/671,286, filed on Apr. 14, 2005.
(60) Provisional application No. 60/672,180, filed on Apr. 14, 2005.

(51) Int. Cl. G02F 2/00

(52) U.S. Cl. 359/325

(57) ABSTRACT

A new differential phase-shift-keyed demodulator is disclosed which can achieve signal demodulation at different wavelengths on ITU grids without requiring active thermal tuning. In accordance with another aspect of the invention, a low-crosstalk demodulator is disclosed which reduces channel leakage by placing neighboring channels at non-optimal interference positions. A demodulator in accordance with the invention may be deployed in a WDM optical system.

This non-provisional application claims the benefit of U.S. Provisional Appl. Serial. No. 60/671,286, entitled “COLORLESS DIFFERENTIAL PHASE-SHIFT-KEYED DEMODULATOR,” and U.S. Provisional Appl. Ser. No. 60/672,180, entitled “LOW CROSSTALK DIFFERENTIAL PHASE-SHIFT-KEYED DEMODULATOR,” both filed Apr. 14, 2005, the contents of which are incorporated by reference herein.

### BACKGROUND OF THE INVENTION

The present invention relates generally to optical networking, and more particularly, to a differential phase shift keyed (DPSK) demodulator for simultaneously demodulating multiple wavelength channels of DPSK communication signals in wavelength division multiplexing (WDM) systems, and a demodulator for reducing crosstalk between neighboring channels in (WDM) systems.

In optical communication systems, data bits are carried on optical fibers by modulating the light intensity, phase, frequency, polarization, and the like. Since the inception of optical fiber communications, the dominant modulation technique has been intensity modulation or on-off-keying (OOK). During the 1980s and early 1990s, research was focused on optical phase modulation, known as phase shift keying (PSK), for the purposes of increasing communication capacity and improving receiver sensitivity. The demodulation of PSK signals requires a local optical oscillator which is coherent to the light emitted by the transmitter. However, these local oscillators are impractical as they are relatively complicated to build. Despite the progresses on the phase and other modulation schemes (such as frequency shift keying (FSK)), by the mid 1990s, the development of erbium doped fiber amplifier (EDFA) and wavelength division multiplexing (WDM) technologies had shifted research efforts to OOK modulation. EDFAs can easily boost signal power, which confers the advantage of higher receiver sensitivity in phase modulation insignificant and WDM can greatly increase system capacity by transmitting a plurality of parallel channels. With OOK modulation and WDM technologies, experimental applications have demonstrated that ultra-dense WDM channels can be transmitted at rates in excess of 10 Tbps.

With increasing line rate and spectral efficiency, traditional direct OOK modulation has certain limitations. One of the major limitations is caused by fiber nonlinearities. Under intensity modulations, random optical power fluctuations of multiple WDM channels can cause signal distortion, optical signal-to-noise-ratio (OSNR) degradation and channel crosstalk. It is difficult to compensate for these detrimental effects, which severely limit the transmission distance at high data rates. In order to extend the reach of 40 Gb/s optical WDM transmissions, new technologies encompassing forward error correction (FEC) and Raman amplifiers have been proposed and demonstrated. Unfortunately, they also increase system cost and complexity.

Compared with intensity modulation, phase modulation has the advantage of greater tolerance to fiber nonlinearities. PSK modulated signals have equalized amplitude and can reduce the influence of nonlinear effect due to random power fluctuations. With balanced detection, PSK signals can have higher receiver sensitivity, which can reduce the optical transmission power and support transmission over greater distances. This led to the development of DPSK, which has become a preferred modulation scheme for 40 Gb/s WDM systems due to a 3 dB benefit in signal receiving and tolerance to fiber nonlinearities. DPSK employs phase of the preceding bit as a relative reference for demodulation. Experimentation has shown that DPSK performance has surpassed conventional OOK modulation in terms of transmission distance and spectral efficiency.

In optical phase modulation systems, signal detection requires coherent demodulation techniques that convert phase information into optical intensity. Demodulation of DPSK signals is typically achieved with a delay interferometer (such as a Mach-Zehnder delay interferometer (MZDI), or Michelson delay interferometer, etc.), phase-to-polarization converter, or ultra-narrow optical bandpass filter. The phase-to-polarization converter uses birefringence in polarization maintaining fiber (PMF) and converts the DPSK signals to polarization modulated signals. The polarization modulated signal can be converted to intensity modulated signal by a polarization splitting element. However, the polarization sensitivity to the input signal makes this approach difficult for practical applications, and the demonstrated systems have not shown any receiver sensitivity improvement for DPSK signals. Expedients using an ultra-narrow optical filter to demodulate the DPSK signal do not fully support balanced detection. A MZDI uses the phase differential between the preceding bit and current bit as a relative reference for demodulation. The one bit period delay between the two arms of MZDI guarantees the maximal overlap. The main challenge for the MZDI-based DPSK demodulators its wavelength dependent operation. The conventional DPSK demodulator, which is based on one-bit-delay interferometers, requires thermal tuning to precisely match input signals at different wavelengths. In DPSK-based WDM systems, separate demodulators with different thermal control settings are required for individual WDM channels, since a different wavelength requires a different precise optical delay for the one-bit-delay based demodulator. This disadvantageously increases system cost.

Another issue affecting WDM systems is channel leakage or crosstalk. An ideal demultiplexer in a WDM system should separate each channel without any crosstalk from neighboring channels. To ensure satisfactory system performance, channel crosstalk should preferably be less than −20 dB. For ˜40 Gb/s optical signals, the bandwidth of modulated signals can be approximately 70-90 GHz. In order to fully demultiplex the WDM signal without experiencing a strong filtering effect, it is desirable to utilize a WDM demultiplexer having a broad pass-band, which can have the deleterious effect of inducing a relatively large crosstalk between neighboring channels. This reduces system performance.

### SUMMARY OF INVENTION

In accordance with a first aspect of the invention, a new DPSK demodulator is disclosed which can achieve signal demodulation at different wavelengths on ITU grids without requiring active thermal tuning. The DPSK demodulator has a delay element tuned for the simultaneous demodulation of multiple channels, which can significantly reduce the costs for DPSK-WDM systems. In an exemplary embodiment, the DPSK demodulator comprises a MZDI configured with a fixed optical delay that is set to guarantee maximal transmission for all WDM channels within a pre-defined spacing. Thus, a 40 Gb/s DPSK demodulator can be set to a fixed optical delay of 20 picoseconds (ps) or free spectral range (FSR) of 50 GHz, which guarantees a maximal transmission for all WDM channels with 100 GHz spacing. The inventors refer to the structure as a “colorless” DPSK demodulator. The colorless DPSK demodulator can be placed in the front of a WDM demultiplexer and simultaneously demodulate all the WDM channels at different wavelengths. By simultaneously processing multiple DPSK-WDM channels at once, the system cost can be significantly reduced when using the new demodulator.

The DPSK demodulator comprises: an input receiving at least two different wavelength channels of differential phase shift keyed communication signals; a delay element which is tuned to simultaneously delay the different wavelength channels so that, when delayed signals are recombined with undelayed signals, the differential phase shift keyed communication signals are converted in parallel to intensity modulated signals for the different wavelength channels. In an exemplary embodiment, the demodulator may be implemented using an interferometer such as a MZDI, Michelson delay interferometer, or the like, to recombine the delayed signals and the undelayed signals.

The DPSK demodulator may be employed in a wavelength division multiplexing (WDM) optical system having a plurality of differential phase-shift keyed (DPSK) transmitters for outputting a plurality of different wavelength channels of DPSK communication signals and a wavelength multiplexer for multiplexing the different wavelength channels of DPSK communication signals. The demodulator is coupled to the wavelength multiplexer and converts the multiplexed DPSK communication signals in parallel to intensity modulated signals for the different wavelength channels. A wavelength demultiplexer is coupled to an output of the DPSK demodulator for demultiplexing the intensity modulated signals into a plurality of demultiplexed intensity modulated signals. The demultiplexed intensity modulated signals are photodetected with single-end detectors. In another embodiment, a pair of demultiplexers are respectively coupled to the constructive port and destructive port of the demodulator to enable balanced detection.

In accordance with another aspect of the invention, a DPSK demodulator is disclosed for reducing crosstalk between neighboring channels. The inventors refer to this expedient as a “low crosstalk” DPSK demodulator. The low crosstalk DPSK demodulator has a delay element tuned for placing neighboring wavelengths on ITU grids at non-optimal interference positions. In an exemplary embodiment, the low crosstalk DPSK demodulator comprises a MZDI configured with a fixed optical delay that is set to reduce channel leakage between all WDM channels within a pre-defined spacing. The WDM channel spacing should be (N+¼) or (N+¾) times the FSR of the demodulator, where N is an integer. In this connection, the FSR should be close to the signal bit rate to reduce the power penalty caused by non-maximal overlap of neighboring bits. Thus, a ˜40 Gb/s DPSK demodulator can be set to a fixed optical delay of 22.5 ps or FSR of ˜44.44 GHz, which minimizes channel crosstalk for all WDM channels with 100 GHz spacing.

These and other advantages of the invention will be apparent to those of ordinary skill in the art by reference to the following detailed description and the accompanying drawings.

### BRIEF DESCRIPTION OF DRAWINGS

FIG. 1 depicts a generic binary DPSK system architecture;

FIG. 2 depicts a typical DPSK receiver employing a MZDI and balanced detectors;

FIG. 3a illustrates the transmission of a MZDI with B=43 Gb/s, fixed delay D=23.26 ps, and micro delay d=0;

FIG. 3b illustrates the same transmission of a MZDI with D=23.26 and d=−0.00089 ps;

FIG. 3c illustrates the same transmission of a MZDI with D=23.26 and d=−0.00026 ps;

FIG. 4 depicts a WDM communication system using prior art DPSK modulation;

FIG. 5 illustrates the transmission of a MZDI configured with a FSR=50 GHz in accordance with an aspect of the invention;

FIG. 6 illustrates parallel demodulation of multiple International Telecommunication Union (ITU) wavelengths in a DPSK-based WDM system with single-end detection;

FIG. 7 illustrates parallel demodulation of multiple ITU wavelengths in a DPSK-based WDM system with balanced detection;

FIG. 8a depicts a VPI simulation setup for a single channel NRZ-DPSK with B=43 Gb/s and an optical delay of 23.2591 ps;

FIG. 8b is the optical spectrum of the NRZ-DPSK signal in the simulation of FIG. 8a;

FIG. 8c are oscilloscope traces of the NRZ-DPSK signal in the simulation of FIG. 8a;

FIG. 8d is the optical spectrum of the output signal from the constructive port of the MZDI in the simulation of FIG. 8a;

FIG. 8e is an eye diagram of the output signal from the constructive port of the MZDI in the simulation of FIG. 8a;

FIG. 8f is the optical spectrum of the output signal from the destructive port of the MZDI in the simulation of FIG. 8a;

FIG. 8g is an eye diagram of the output signal from the destructive port of the MZDI in the simulation of FIG. 8a;

FIG. 8h is an eye diagram of the demodulated DPSK signal when the central frequency of the laser is 193.0 Thz in the simulation of FIG. 8a;

FIG. 8i is an eye diagram of the demodulated DPSK signal when the central frequency of the laser is 193.1 Thz in the simulation of FIG. 8a;

FIG. 9a is an eye diagram of the demodulated DPSK signal when the central frequency of the laser is 193.1 Thz when the optical delay was changed to 23.2574 ps in the simulation of FIG. 8a;

FIG. 9b is an eye diagram of the demodulated DPSK signal when the central frequency of the laser is 193.0 Thz when the optical delay was changed to 23.2574 ps in the simulation of FIG. 8a;

FIG. 10a is the optical spectrum of the output signal from the constructive port of the MZDI in the simulation of FIG. 8a using a FSR=50 GHz;

FIG. 10b is an eye diagram of the output signal from the constructive port of the MZDI in the simulation of FIG. 8a using a FSR=50 GHz;

FIG. 10c is the optical spectrum of the output signal from the destructive port of the MZDI in the simulation of FIG. 8a using a FSR=50 GHz;

FIG. 10d is an eye diagram of the output signal from the destructive port of the MZDI in the simulation of FIG. 8a using a FSR=50 GHz;

FIG. 10e is an eye diagram of the demodulated DPSK signal when the central frequency of the laser is 193.0 Thz in the simulation of FIG. 8a using a FSR=50 GHz;

FIG. 10f is an eye diagram of the demodulated DPSK signal when the central frequency of the laser is 193.1 Thz in the simulation of FIG. 8a using a FSR=50 GHz;

FIG. 11 depicts the working principle for 40 Gb/s NRZ-DPSK signal demodulation using a MZDI with a FSR=50 GHz;

FIG. 12a depicts a VPI simulation setup for a single channel RZ-DPSK with B=43 Gb/s when the central frequency of the laser is 193.0 THz, and an optical delay of 23.2591 ps;

FIG. 12b is the optical spectrum of the modulated RZ-DPSK signal in the simulation of FIG. 12a;

FIG. 12c are oscilloscope traces of the modulated RZ-DPSK signal in the simulation of FIG. 12a;

FIG. 12d is the optical spectrum of the output signal from the constructive port of the MZDI in the simulation of FIG. 12a;

FIG. 12e is an eye diagram of the output signal from the constructive port of the MZDI in the simulation of FIG. 12a;

FIG. 12f is the optical spectrum of the output signal from the destructive port of the MZDI in the simulation of FIG. 12a;

FIG. 12g is an eye diagram of the output signal from the destructive port of the MZDI in the simulation of FIG. 12a;

FIG. 12h is an eye diagram of the demodulated RZ-DPSK signal in the simulation of FIG. 12a with Q=33.4;

FIG. 13a1 is an eye diagram of the output signal from the constructive port of the MZDI in the simulation of FIG. 12a with the central frequency of the laser at 192.9 THz and Q=14.4;

FIG. 13a2 is an eye diagram of the output signal from the destructive port of the MZDI in the simulation of FIG. 12a with the central frequency of the laser at 192.9 THz and Q=14.4;

FIG. 13a3 is an eye diagram of the output signal from balanced detectors in the simulation of FIG. 12a with the central frequency of the laser at 192.9 THz and Q=14.4;

FIG. 13b1 is an eye diagram of the output signal from the constructive port of the MZDI in the simulation of FIG. 12a with the central frequency of the laser at 193.1 THz and Q=16.6;

FIG. 13b2 an eye diagram of the output signal from the destructive port of the MZDI in the simulation of FIG. 12a with the central frequency of the laser at 193.1 THz and Q=16.6;

FIG. 13b3 is an eye diagram of the output signal from balanced detectors in the simulation of FIG. 12a with the central frequency of the laser at 193.1 THz and Q=16.6;

FIG. 13c1 is an eye diagram of the output signal from the constructive port of the MZDI in the simulation of FIG. 12a with the central frequency of the laser at 193.3 THz and Q=34.8;

FIG. 13c2 is an eye diagram of the output signal from the destructive port of the MZDI in the simulation of FIG. 12a with the central frequency of the laser at 193.3 THz and Q=34.8;

FIG. 13c3 is an eye diagram of the output signal from balanced detectors in the simulation of FIG. 12a with the central frequency of the laser at 193.3 THz and Q=34.8;

FIG. 13d1 is an eye diagram of the output signal from the constructive port of the MZDI in the simulation of FIG. 12a with the central frequency of the laser at 193.4 THz and Q=12.8;

FIG. 13d2 is an eye diagram of the output signal from the destructive port of the MZDI in the simulation of FIG. 12a with the central frequency of the laser at 193.4 THz and Q=12.8;

FIG. 13d3 is an eye diagram of the output signal from balanced detectors in the simulation of FIG. 12a with the central frequency of the laser at 193.4 THz and Q=12.8;

FIG. 14a1 is an eye diagram of the output signal from the constructive port of the MZDI in the simulation of FIG. 12a using a MZDI with an optical delay of 20 ps (FSR=50 GHz) with the central frequency of the laser at 192.9 THz and Q=33.0;

FIG. 14a2 is an eye diagram of the output signal from the destructive port of the MZDI in the simulation of FIG. 12a using a MZDI with an optical delay of 20 ps (FSR=50 GHz) with the central frequency of the laser at 192.9 THz and Q=33.0;

FIG. 14a3 is an eye diagram of the output signal from balanced detectors in the simulation of FIG. 12a using a MZDI with an optical delay of 20 ps (FSR=50 GHz) with the central frequency of the laser at 192.9 THz and Q=33.0;

FIG. 14 b1 is an eye diagram of the output signal from the constructive port of the MZDI in the simulation of FIG. 12a using a MZDI with an optical delay of 20 ps (FSR=50 GHz) with the central frequency of the laser at 193.0 THz and Q=32.8;

FIG. 14b2 is an eye diagram of the output signal from the destructive port of the MZDI in the simulation of FIG. 12a using a MZDI with an optical delay of 20 ps (FSR=50 GHz) with the central frequency of the laser at 193.0 THz and Q=32.8;

FIG. 14b3 is an eye diagram of the output signal from balanced detectors in the simulation of FIG. 12a using a MZDI with an optical delay of 20 ps (FSR=50 GHz) with the central frequency of the laser at 193.0 THz and Q=32.8;

FIG. 14c1 is an eye diagram of the output signal from the constructive port of the MZDI in the simulation of FIG. 12a using a MZDI with an optical delay of 20 ps (FSR=50 GHz) with the central frequency of the laser at 193.3 THz and Q=33.8;

FIG. 14c2 is an eye diagram of the output signal from the destructive port of the MZDI in the simulation of FIG. 12a using a MZDI with an optical delay of 20 ps (FSR=50 GHz) with the central frequency of the laser at 193.3 THz and Q=33.8;

FIG. 14c3 is an eye diagram of the output signal from balanced detectors in the simulation of FIG. 12a using a MZDI with an optical delay of 20 ps (FSR=50 GHz) with the central frequency of the laser at 193.3 THz and Q=33.8;

FIG. 14d1 is an eye diagram of the output signal from the constructive port of the MZDI in the simulation of FIG. 12a using a MZDI with an optical delay of 20 ps (FSR=50 GHz) with the central frequency of the laser at 193.4 THz and Q=31.4;

FIG. 14d2 is an eye diagram of the output signal from the destructive port of the MZDI in the simulation of FIG. 12a using a MZDI with an optical delay of 20 ps (FSR=50 GHz) with the central frequency of the laser at 193.4 THz and Q=31.4;

FIG. 14d3 is an eye diagram of the output signal from balanced detectors in the simulation of FIG. 12a using a MZDI with an optical delay of 20 ps (FSR=50 GHz) with the central frequency of the laser at 193.4 THz and Q=31.4;

FIG. 15a depicts Q factor vs. duty cycle for one-bit-delay and 20 ps delay MZDIs at B=43 Gb/s with the optical power prior to the MZDI for a NRZ-DPSK signal of −10.8 dBm, RZ(33% duty cycle)-DPSK of −13.1 dBm, and RZ(67% duty cycle)-DPSK of −12.2 dBm;

FIG. 15b depicts the Q factor vs. duty cycle under the same conditions as FIG. 15a for B=40 Gb/s;

FIG. 16a depicts Q factor vs. frequency offset from 193.0 THz at B=43 Gb/s for a NRZ-DPSK signal;

FIG. 16b depicts Q factor vs. frequency offset from 193.0 THz at B=43 Gb/s for a 67% RZ-DPSK signal;

FIG. 16c depicts Q factor vs. frequency offset from 193.0 THz at B=43 Gb/s for a 33% RZ-DPSK signal;

FIG. 17a depicts a VPI simulation setup for DPSK-WDM systems using a one-bit-delay MZDI for each wavelength where B=43 Gb/s for a 67% RZ-DPSK signal, filter bandwidth (3 dB) of 86 GHz, with channel 1 (f=193.0 THz, delay=23.2487 ps); channel 2 (f=193.1 THz, delay=23.2522 ps); channel 3 (f=193.2 THz, delay=23.2505 ps); and channel 4 (f=193.3 THz, delay=23.2540 ps);

FIG. 17b depicts the optical spectrum of the DPSK-WDM signals in the simulation of FIG. 17a;

FIG. 17c is an eye diagram of channel 1 with Q=14.6;

FIG. 17d is an eye diagram of channel 2 with Q=13.7;

FIG. 17e is an eye diagram of channel 3 with Q=13.6;

FIG. 17f is an eye diagram of channel 4 with Q=15.1;

FIG. 18a is a VPI simulation setup for DPSK-WDM systems using a 20 ps-delay MZDI in accordance with the invention, where B=43 Gb/s for a 67% RZ-DPSK signal, filter bandwidth (3 dB) of 86 GHz, with channel 1 (f=193.0 THz); channel 2 (f=193.1 THz); channel 3 (f=193.2 THz); and channel 4 (f=193.3 THz);

FIG. 18b depicts the optical spectrum of the DPSK-WDM signals in the simulation of FIG. 17a from the constructive port of the MZDI;

FIG. 18c depicts the optical spectrum of the DPSK-WDM signals in the simulation of FIG. 17a from the destructive port of the MZDI;

FIG. 18d is an eye diagram of channel 1 with Q=13.4;

FIG. 18e is an eye diagram of channel 2 with Q=12.2;

FIG. 18f is an eye diagram of channel 3 with Q=12.4;

FIG. 18g is an eye diagram of channel 4 with Q=14.1;

FIG. 19 depicts illustrative reconfigurable add-drop demultiplexers utilizing a colorless MZDI in accordance with an aspect of the invention;

FIG. 20a depicts the transmission of a one-bit-delay MZDI with balanced detection with B=43 Gb/s, an optical delay of 23.2522 ps and DPSK signal frequency of 193.1 THz, with the solid line showing the transmission curve for Δφ=0 and the dotted line showing the transmission curve for Δφ=π;

FIG. 20b depicts the transmission of a one-bit-delay MZDI with balanced detection with B=40 Gb/s, an optical delay of 25.0026 ps and DPSK signal frequency of 193.1 THz, with the solid line showing the transmission curve for Δφ=0 and the dotted line showing the transmission curve for Δφ=π;

FIG. 20c depicts the transmission of a low crosstalk MZDI in accordance with an aspect of the invention, with balanced detection with B=40 Gb/s, an optical delay of 22.5013 ps and DPSK signal frequency of 193.1 THz, with the solid line showing the transmission curve for Δφ=0 and the dotted line showing the transmission curve for Δφ=π;

FIG. 21 is a VPI simulation setup for single channel DPSK systems;

FIG. 22a1 is an eye diagram of the output signal from the constructive port of the MZDI in the simulation of FIG. 21 using a one-bit-delay MZDI with B=43 Gb/s and an optical delay of 23.2522 ps with the central frequency of the laser at 193.1 THz;

FIG. 22a2 is an eye diagram of the output signal from the destructive port of the MZDI in the simulation of FIG. 21 using a one-bit-delay MZDI with B=43 Gb/s and an optical delay of 23.2522 ps with the central frequency of the laser at 193.1 THz;

FIG. 22a3 is an eye diagram of the received signal in the simulation of FIG. 21 using a one-bit-delay MZDI with B=43 Gb/s and an optical delay of 23.2522 ps with the central frequency of the laser at 193.1 THz;

FIG. 22b1 is an eye diagram of the output signal from the constructive port of the MZDI in the simulation of FIG. 21 with the central frequency of the laser at 193.0 THz;

FIG. 22b2 is an eye diagram of the output signal from the destructive port of the MZDI in the simulation of FIG. 21 using a one-bit-delay MZDI with B=43 Gb/s and an optical delay of 23.2522 ps with the central frequency of the laser at 193.0 THz;

FIG. 22b3 is an eye diagram of the received signal in the simulation of FIG. 21 using a one-bit-delay MZDI with B=43 Gb/s and an optical delay of 23.2522 ps with the central frequency of the laser at 193.0 THz;

FIG. 22c1 is an eye diagram of the output signal from the constructive port of the MZDI in the simulation of FIG. 21 using a one-bit-delay MZDI with B=43 Gb/s and an optical delay of 23.2522 ps with the central frequency of the laser at 193.2 THz;

FIG. 22c2 is an eye diagram of the output signal from the destructive port of the MZDI in the simulation of FIG. 21 using a one-bit-delay MZDI with B=43 Gb/s and an optical delay of 23.2522 ps with the central frequency of the laser at 193.2 THz;

FIG. 22c3 is an eye diagram of the received signal in the simulation of FIG. 21 using a one-bit-delay MZDI with B=43 Gb/s and an optical delay of 23.2522 ps with the central frequency of the laser at 193.2 THz;

FIG. 23a1 is an eye diagram of the output signal from the constructive port of the MZDI in the simulation of FIG. 21 using a low crosstalk MZDI in accordance with an aspect of the invention with B=43 Gb/s and an optical delay of 22.5013 ps with the central frequency of the laser at 193.1 THz;

FIG. 23a2 is an eye diagram of the output signal from the destructive port of the MZDI in the simulation of FIG. 21 using a low crosstalk MZDI in accordance with an aspect of the invention with B=43 Gb/s and an optical delay of 22.5013 ps with the central frequency of the laser at 193.1 THz;

FIG. 23a3 is an eye diagram of the received signal in the simulation of FIG. 21 using a low crosstalk MZDI in accordance with an aspect of the invention with B=43 Gb/s and an optical delay of 22.5013 ps with the central frequency of the laser at 193.1 THz;

FIG. 23b1 is an eye diagram of the output signal from the constructive port of the MZDI in the simulation of FIG. 21 using a low crosstalk MZDI in accordance with an aspect of the invention with B=43 Gb/s and an optical delay of 22.5013 ps with the central frequency of the laser at 193.0 THz;

FIG. 23b2 is an eye diagram of the output signal from the destructive port of the MZDI in the simulation of FIG. 21 using a low crosstalk MZDI in accordance with an aspect of the invention with B=43 Gb/s and an optical delay of 22.5013 ps with the central frequency of the laser at 193.0 THz;

FIG. 23b3 is an eye diagram of the received signal in the simulation of FIG. 21 using a low crosstalk MZDI in accordance with an aspect of the invention with B=43 Gb/s and an optical delay of 22.5013 ps with the central frequency of the laser at 193.0 THz;

FIG. 23c1 is an eye diagram of the output signal from the constructive port of the MZDI in the simulation of FIG. 21 using a low crosstalk MZDI in accordance with an aspect of the invention with B=43 Gb/s and an optical delay of 22.5013 ps with the central frequency of the laser at 193.2 THz;

FIG. 23c2 is an eye diagram of the output signal from the destructive port of the MZDI in the simulation of FIG. 21 using a low crosstalk MZDI in accordance with an aspect of the invention with B=43 Gb/s and an optical delay of 22.5013 ps with the central frequency of the laser at 193.2 THz;

FIG. 23c3 is an eye diagram of the received signal in the simulation of FIG. 21 using a low crosstalk MZDI in accordance with an aspect of the invention with B=43 Gb/s and an optical delay of 22.5013 ps with the central frequency of the laser at 193.2 THz;

FIG. 24a1 is an eye diagram of the output signal from the constructive port of the MZDI in the simulation of FIG. 21 using a one-bit-delay MZDI with B=40 Gb/s and an optical delay of 25.0026 ps with the central frequency of the laser at 193.1 THz;

FIG. 24a2 is an eye diagram of the output signal from the destructive port of the MZDI in the simulation of FIG. 21 using a one-bit-delay MZDI with B=40 Gb/s and an optical delay of 25.0026 ps with the central frequency of the laser at 193.1 THz;

FIG. 24a3 is an eye diagram of the received signal in the simulation of FIG. 21 using a one-bit-delay MZDI with B=40 Gb/s and an optical delay of 25.0026 ps with the central frequency of the laser at 193.1 THz;

FIG. 24b1 is an eye diagram of the output signal from the constructive port of the MZDI in the simulation of FIG. 21 using a one-bit-delay MZDI with B=40 Gb/s and an optical delay of 25.0026 ps with the central frequency of the laser at 193.0 THz;

FIG. 24b2 is an eye diagram of the output signal from the destructive port of the MZDI in the simulation of FIG. 21 using a one-bit-delay MZDI with B=40 Gb/s and an optical delay of 25.0026 ps with the central frequency of the laser at 193.0 THz;

FIG. 24b3 is an eye diagram of the received signal in the simulation of FIG. 21 using a one-bit-delay MZDI with B=40 Gb/s and an optical delay of 25.0026 ps with the central frequency of the laser at 193.0 THz;

FIG. 24c1 is an eye diagram of the output signal from the constructive port of the MZDI in the simulation of FIG. 21 using a one-bit-delay MZDI with B=40 Gb/s and an optical delay of 25.0026 ps with the central frequency of the laser at 193.2 THz;

FIG. 24c2 is an eye diagram of the output signal from the destructive port of the MZDI in the simulation of FIG. 21 using a one-bit-delay MZDI with B=40 Gb/s and an optical delay of 25.0026 ps with the central frequency of the laser at 193.2 THz;

FIG. 24c3 is an eye diagram of the received signal in the simulation of FIG. 21 using a one-bit-delay MZDI with B=40 Gb/s and an optical delay of 25.0026 ps with the central frequency of the laser at 193.2 THz;

FIG. 25a1 is an eye diagram of the output signal from the constructive port of the MZDI in the simulation of FIG. 21 using a low crosstalk MZDI in accordance with an aspect of the invention with B=40 Gb/s and an optical delay of 22.5013 ps with the central frequency of the laser at 193.1 THz;

FIG. 25a2 is an eye diagram of the output signal from the destructive port of the MZDI in the simulation of FIG. 21 using a low crosstalk MZDI in accordance with an aspect of the invention with B=40 Gb/s and an optical delay of 22.5013 ps with the central frequency of the laser at 193.1 THz;

FIG. 25a3 is an eye diagram of the received signal in the simulation of FIG. 21 using a low crosstalk MZDI in accordance with an aspect of the invention with B=40 Gb/s and an optical delay of 22.5013 ps with the central frequency of the laser at 193.1 THz;

FIG. 25b1 is an eye diagram of the output signal from the constructive port of the MZDI in the simulation of FIG. 21 using a low crosstalk MZDI in accordance with an aspect of the invention with B=40 Gb/s and an optical delay of 22.5013 ps with the central frequency of the laser at 193.0 THz;

FIG. 25b2 is an eye diagram of the output signal from the destructive port of the MZDI in the simulation of FIG. 21 using a low crosstalk MZDI in accordance with an aspect of the invention with B=40 Gb/s and an optical delay of 22.5013 ps with the central frequency of the laser at 193.0 THz;

FIG. 25b3 is an eye diagram of the received signal in the simulation of FIG. 21 using a low crosstalk MZDI in accordance with an aspect of the invention with B=40 Gb/s and an optical delay of 22.5013 ps with the central frequency of the laser at 193.0 THz;

FIG. 25c1 is an eye diagram of the output signal from the constructive port of the MZDI in the simulation of FIG. 21 using a low crosstalk MZDI in accordance with an aspect of the invention with B=40 Gb/s and an optical delay of 22.5013 ps with the central frequency of the laser at 193.2 THz;

FIG. 25c2 is an eye diagram of the output signal from the destructive port of the MZDI in the simulation of FIG. 21 using a low crosstalk MZDI in accordance with an aspect of the invention with B=40 Gb/s and an optical delay of 22.5013 ps with the central frequency of the laser at 193.2 THz;

FIG. 25c3 is an eye diagram of the received signal in the simulation of FIG. 21 using a low crosstalk MZDI in accordance with an aspect of the invention with B=40 Gb/s and an optical delay of 22.5013 ps with the central frequency of the laser at 193.2 THz;

FIG. 26 is a VPI simulation setup for an exemplary 8-channel DPSK system;

FIG. 27a is transmission curve of a WDM demultiplexer port (3 dB bandwidth=90 GHz) in the simulation of FIG. 26;

FIG. 27b depicts the optical spectrum of the multiplexed WDM signals in the simulation of FIG. 26;

FIG. 28a is an eye diagram of received channel 1 with Q=13.3 using the one-bit-delay MZDI;

FIG. 28b is an eye diagram of received channel 2 with Q=11.3 using the one-bit-delay MZDI;

FIG. 28c is an eye diagram of received channel 3 with Q=11.2 using the one-bit-delay MZDI;

FIG. 28d is an eye diagram of received channel 4 with Q=11.4 using the one-bit-delay MZDI;

FIG. 28e is an eye diagram of received channel 5 with Q=11.2 using the one-bit-delay MZDI;

FIG. 28f is an eye diagram of received channel 6 with Q=11.5 using the one-bit-delay MZDI;

FIG. 28g is an eye diagram of received channel 7 with Q=10.9 using the one-bit-delay MZDI;

FIG. 28h is an eye diagram of received channel 8 with Q=13.5 using the one-bit-delay MZDI;

FIG. 29a is an eye diagram of received channel 1 with Q=16.9 using the low crosstalk MZDI in accordance with an aspect of the invention;

FIG. 29b is an eye diagram of received channel 2 with Q=15.1 using the low crosstalk MZDI in accordance with an aspect of the invention;

FIG. 29c is an eye diagram of received channel 3 with Q=15.3 using the low crosstalk MZDI in accordance with an aspect of the invention;

FIG. 29d is an eye diagram of received channel 4 with Q=15.5 using the low crosstalk MZDI in accordance with an aspect of the invention;

FIG. 29e is an eye diagram of received channel 5 with Q=14.7 using the low crosstalk MZDI in accordance with an aspect of the invention;

FIG. 29f is an eye diagram of received channel 6 with Q=16.2 using the low crosstalk MZDI in accordance with an aspect of the invention;

FIG. 29g is an eye diagram of received channel 7 with Q=15.1 using the low crosstalk MZDI in accordance with an aspect of the invention; and

FIG. 29h is an eye diagram of received channel 8 with Q=16.3 using the low crosstalk MZDI in accordance with an aspect of the invention.

### DETAILED DESCRIPTION OF THE PREFERRED EMBODIMENTS

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

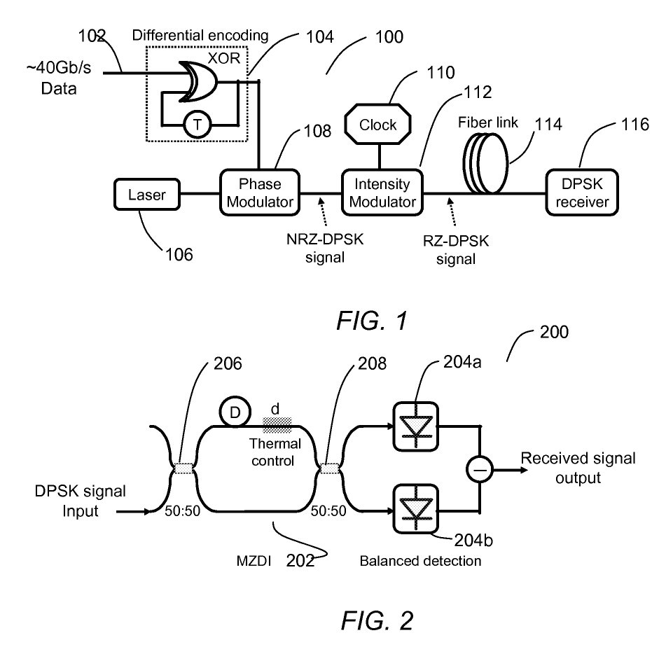

FIG. 1 is a schematic depicting a generic binary DPSK system architecture 100. An ˜40 GB/s input data signal 102 is differentially encoded at 104 through a one-bit-delay exclusive OR operation. The encoded data from differential encoder 104 modulate the phase of light output from a continuous wave laser 106 at phase modulator 108. A non-return to zero (NRZ)-DPSK signal is output from phase modulator 108, where the phase change exists in the whole bit period. However, since phase modulation does not occur instantaneously, a “chirp” (where phase changes with time) occurs during bit transitions. A chirp causes extra spectral broadening of the signal, and can result in more dramatic dispersion during signal transmission in fiber. A clock 110 driven intensity modulator 112 can be employed to carve pulses out of the phase-modulated signal, thus eliminating the chirp from the signal. The generated signal is known as a return-to-zero (RZ) DPSK signal, and it has been shown to be appropriate for high-speed, long distance transmission over a fiber link 114. At the receiver 116, the DPSK signal can be detected through a delay interferometer followed by single or balanced photodetectors.

FIG. 2 is a schematic of a typical DPSK receiver 200 employing a MZDI 202 and balanced photodetectors 204a, 204b. The MZDI 202 has an input optical coupler 206 for receiving an input light signal through two arms of the input coupler 206 and an output optical coupler 208 having a destructive port and constructive port coupled to the balanced photodetectors 204a, 204b. The MZDI 202 has an optical delay of one bit period for the interference of two adjacent bits. In practical applications, the optical delay in the MZDI is achieved through a combination of a macro one-bit-delay (D) which is fixed in design and a micro delay (d) which can be altered through thermal tuning, as depicted in FIG. 2.

Assuming noise-free continuous wave input, the transmission at the constructive port of a MZDI can be derived as:

$$T = \frac{1}{2} ( 1 + cos ( 2 π f ( D + d ) ) ) \qquad ( 1 )$$

The transmission at the destructive port of the MZDI is derived as:

$$T = \frac{1}{2} ( 1 - cos ( 2 π f ( D + d ) ) ) \qquad ( 2 )$$

where f is the light frequency, D

$$D = \frac{1}{B} , D >> d ,$$

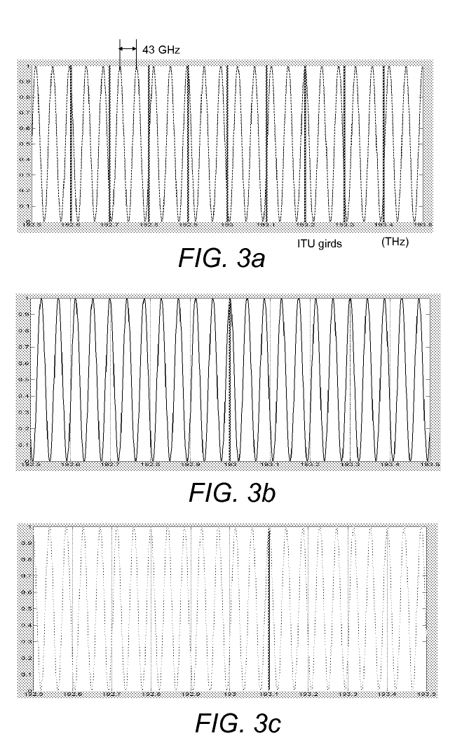

B is the bit repetition rate of the input signal. In a general case, when B=43 Gb/s (the bit rate for 40 Gb/s signal with forward error correction), the transmission T under fixed D (one bit period of 43 Gb/s, or 23.26 ps) and different d values are shown in FIGS. 3a, 3b and 3c. The dark lines show the ITU grid wavelengths under 100 GHz spacing. When there is no thermal tuning (assume d=0), the transmission of the ITU wavelengths is at a random value, as shown in FIG. 3a. The free spectral range (FSR) of the MZDI is decided by

$$\frac{1}{D + d} .$$

One can change the value of d through thermal tuning to optimize the transmission at a certain wavelength. For example, an optimal output at ITU wavelength of 193 THz with d=−0.00089 ps can be obtained, as shown in FIG. 3b. However, the transmission at other ITU grids is generally not optimized. One has to tune d to optimize the transmission of MZDI for input signal at another wavelength. In FIG. 3c, d is changed to −0.0026 ps for optimized transmission at ITU wavelength 193.1 THz. Accordingly, it can be observed that the MZDI-based optical DPSK demodulators are generally wavelength dependent and the optical delay has to be precisely tuned for input signals at different wavelengths.

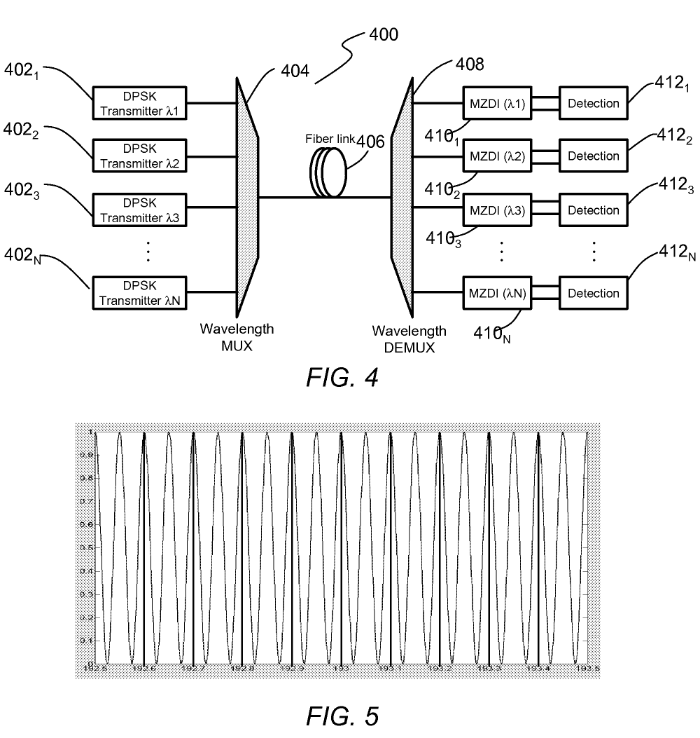

Referring now to FIG. 4, there is shown a schematic of a typical WDM system 400 having a plurality of DPSK transmitters 402₁, 402₂, 402₃ . . . 402_{N} operating at respective wavelengths λ₁, λ₂ λ₃ . . . λ_{N}, and coupled to a wavelength multiplexer (WMUX) 404. The resulting multiplexed signal is communicated over fiber link 406 to a wavelength demultiplexer (WDMUX) 408, which produces demultiplexed output signals λ₁, λ₂ λ₃ . . . λ_{N}. The wavelength dependent operation requires a separate MZDI 410₁, 410₂, 410₃ . . . λ_{N} for each WDM channel. The output ports of each MZDI 410₁, 410₂, 410₃ . . . 410_{N} are then applied to detectors 412₁, 412₂, 412₃ . . . 412_{N}. The wavelength dependence of each MZDI thus dramatically increases the overall system cost. In addition, the need for thermal tuning also contributes to increased costs.

In accordance with an aspect of the invention, equation (1) can be rewritten as follows:

$$T = \frac{1}{2} ( 1 + cos ( 2 π \frac{f}{FSR} ) ) \qquad ( 3 )$$

where FSR is the spectral range of the MZDI, and decided by

$$\frac{1}{D + d} .$$

For one-bit-delay interference, FSR≈B. When the input wavelengths are at ITU grids, the spacing of f is 100 GHz. In a general case, the FSR of the MZDI can be finely adjusted to optimize the transmission of one ITU grid wavelength (

$$\frac{f}{FSR}$$

is an integer), but not all the ITU grid wavelengths. However, in a special case, when FSR=50 GHz, all the ITU grid wavelengths can have optimized transmission, as shown in FIG. 5. For 50 GHz FSR, the optical delay becomes 20 ps, which corresponds to an ideal bit rate of 50 Gb/s. Due to upgrades in SONET standard bit rate, the standard bit rate of the OC-768 transmission is about 40 Gb/s, or 42.65 Gb/s with the use of ITU-T G.709 FEC. Using a MZDI with a 20 ps delay (50 GHz FSR) for a ˜40 Gb/s DPSK communication system is advantageous in that the demodulator becomes wavelength independent for signals on ITU grids. The potential penalty is that the optical signal-to-noise ratio OSNR of the demodulated signal may decrease due to the non-maximal overlap of the adjacent bits.

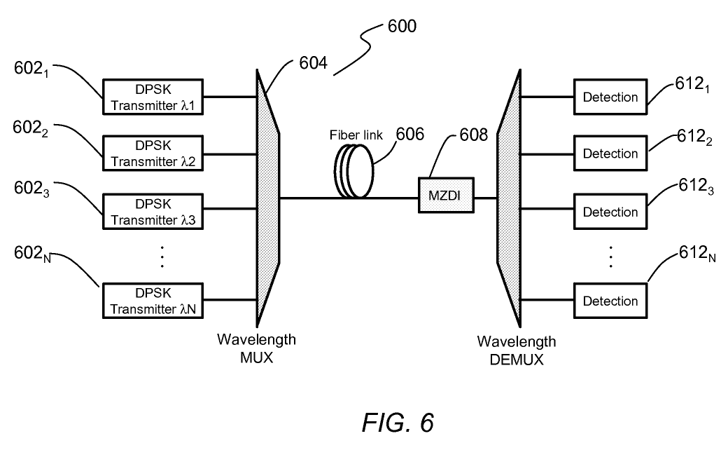

In accordance with an aspect of the invention, an ITU-wavelength-independent DPSK demodulator has a fixed optical delay of 20 ps, therefore obviating the need for thermal tuning once the bit delay is precisely fixed and stabilized. An exemplary demodulator can achieve simultaneous demodulation of multiple WDM wavelengths on ITU grids. In this regard, FIG. 6 depicts an exemplary WDM system 600 in accordance with an aspect of the invention. WDM system 600 includes a plurality of DPSK transmitters 602₁, 602₂, 602₃ . . . 602_{N} operating at respective wavelengths λ₁, λ₂ λ₃ . . . λ_{N}, and coupled to a WMUX 604. The resulting multiplexed signal is communicated over fiber link 606 to a colorless 20 ps-delay MZDI 608, which simultaneously converts the WDM DPSK signal to produce intensity modulated signals that are then applied to WDMUX 610. In the exemplary application depicted in FIG. 6, one of the output ports of the MZDI 608 communicates the intensity modulated signals to the input port of the DMUX 610, which then produces individual signals at wavelengths λ₁, λ₂ λ₃ . . . λ_{N} that are detectable with single-end detectors 612₁, 612₂, 612₃ . . . 612_{N}.

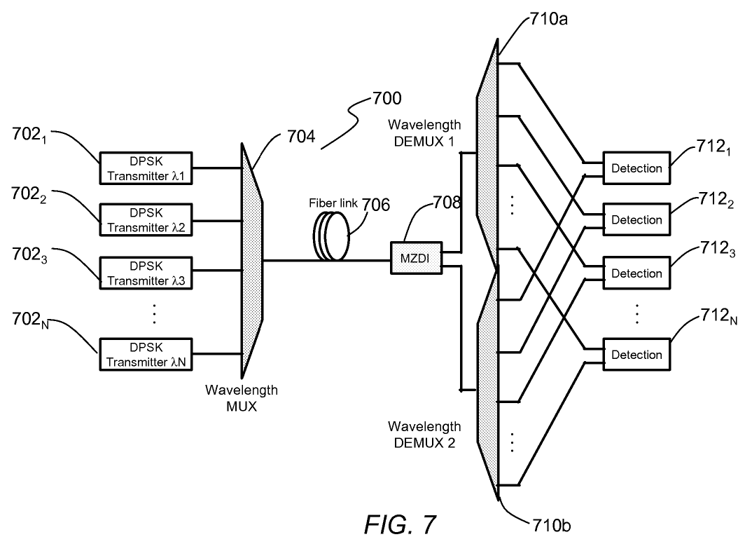

Referring now to FIG. 7, there is depicted another WDM system 700 in accordance with an aspect of the invention, having a plurality of DPSK transmitters 702₁, 702₂, 702₃ . . . 702_{N} operating at respective wavelengths λ₁, λ₂ λ₃ . . . λ_{N}, and coupled to a WMUX 704. The resulting multiplexed signal is communicated over fiber link 706 to a colorless 20 ps-delay MZDI 708, which simultaneously converts the WDM DPSK signal to produce intensity modulated signals that are then applied via the two output ports (i.e., constructive and destructive) of MZDI 708 to a first WDMUX DMUX 710a and a second WDMUX 710b. The output ports of WDMUXs 710a, 710b provide demultiplexed signals at wavelengths λ₁, λ₂ λ₃ . . . λ_{N} to the respective parallel input ports of balanced detectors 712₁, 712₂, 712₃ . . . 712_{N}, which photodetect the signals as described in the foregoing.

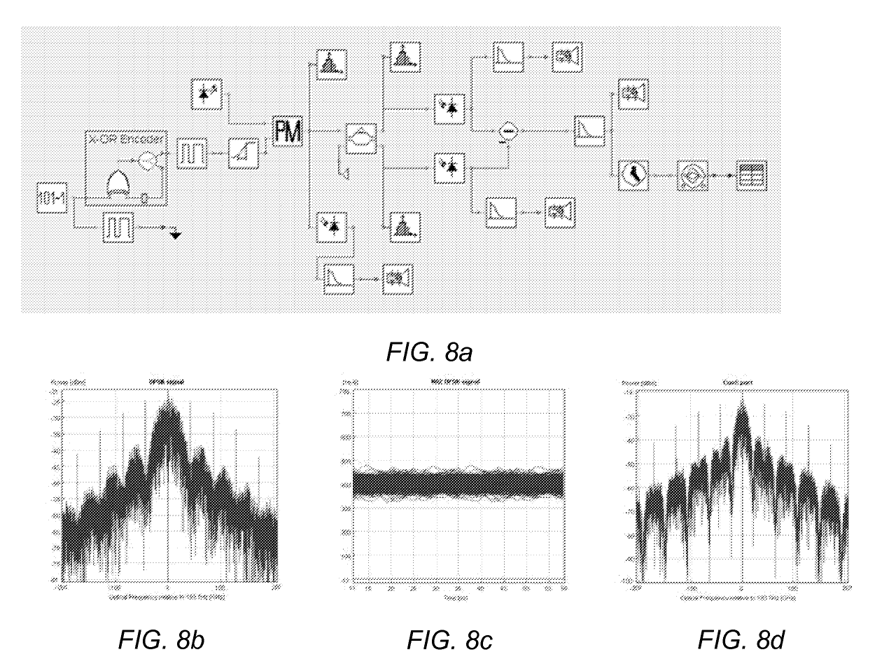

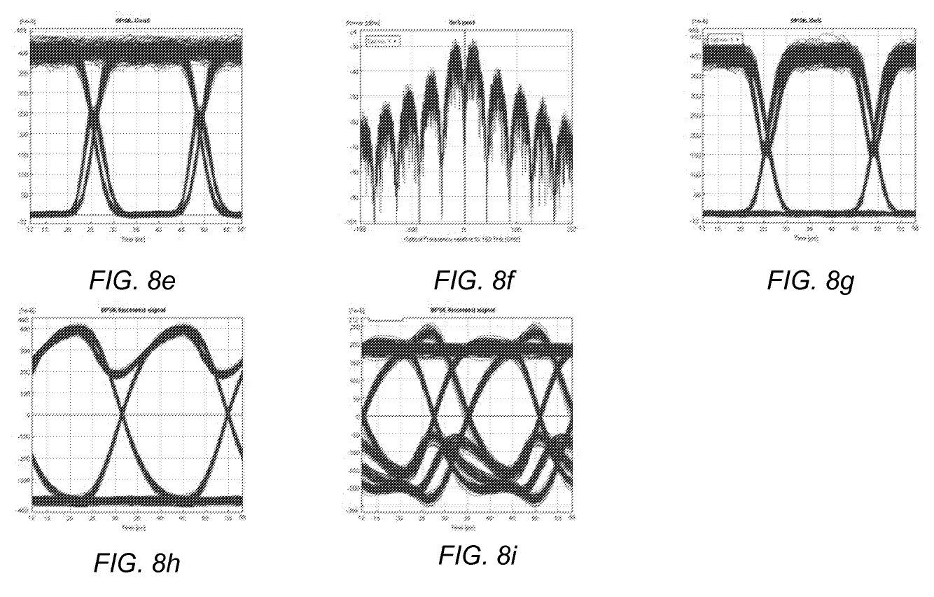

Simulations were conducted on DPSK systems and under different working conditions to evaluate performance using VPItransmissionMaker, which is a fourth generation photonic design automation tool that can perform extensive simulations to deliver results which are comparable with real life applications. VPItransmission maker is available from VPIphotonics™ design automation, a division of VPIsystems®. FIG. 8a depicts the setup for the VPI simulation. The central frequency of the laser is set to 193.0 THz. The bit rate of the input signal is at 43 Gb/s, and the corresponding one-bit-delay is 23.256 ps. Considering the requirement for optimal interference, the optical delay of MZDI is set to be 23.2591 ps for 193.0 THz (so that f·delay is almost an integer number). The average optical power before MZDI is −4 dBm. The optical spectrum and oscilloscope traces of the modulated NRZ-DPSK signal are shown in FIGS. 8b and 8c, respectively. The NRZ-DPSK signal has equalized amplitude. The optical spectrum of the output signal from the constructive port of the MZDI is depicted in FIG. 8d and a corresponding oscilloscope trace or eye diagram (with the detector bandwidth set to 2*B) is shown in FIG. 8e. The optical spectrum of the output signal from the destructive port of the MZDI is shown in FIG. 8f and the corresponding eye diagram is depicted in FIG. 8g. It will be appreciated that the spectral width of the output signal from the constructive port is narrower than the input signal. Through balanced detection, an eye diagram of the received DPSK (with the detector bandwidth set to 0.7*B to simulate receivers) is shown in FIG. 7h.

When the optical delay in the MZDI (23.2591 ps) was maintained and the central frequency of the laser changed to another ITU grid of 193.1 THz, the resulting eye diagram of the received DPSK signal is shown in FIG. 8i. The degradation of the eye diagram is due to the non-optimal interference where f·delay (193.1 THz*23.2591 ps) is not an integer.

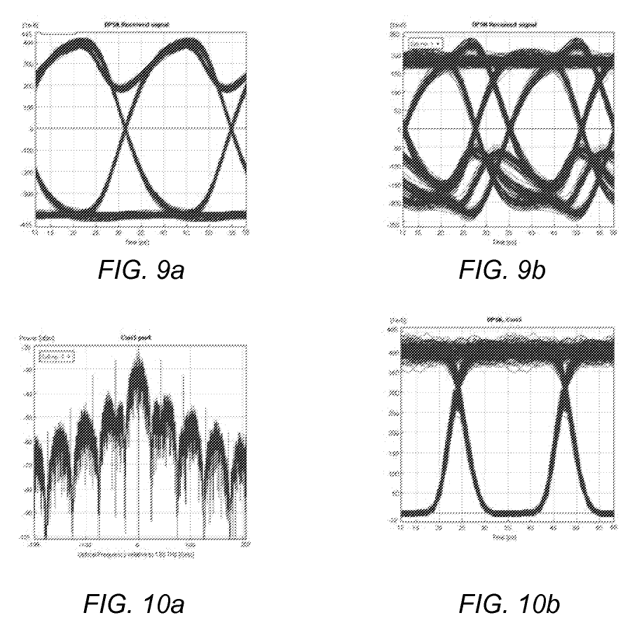

When the optical delay in the MZDI was changed to be 23.2574 ps, which is optimized for a central frequency of 193.1 THz, the eye diagram of the received DPSK signal is shown in FIG. 9a. In this case, changing the central frequency of the laser back to 193.0 THz, produced an eye diagram for the received signal as shown in FIG. 9b.

It will be appreciated by those skilled in the art that this simulation demonstrates that a one-bit-delay MZDI has to be finely tuned for input signals at different wavelengths.

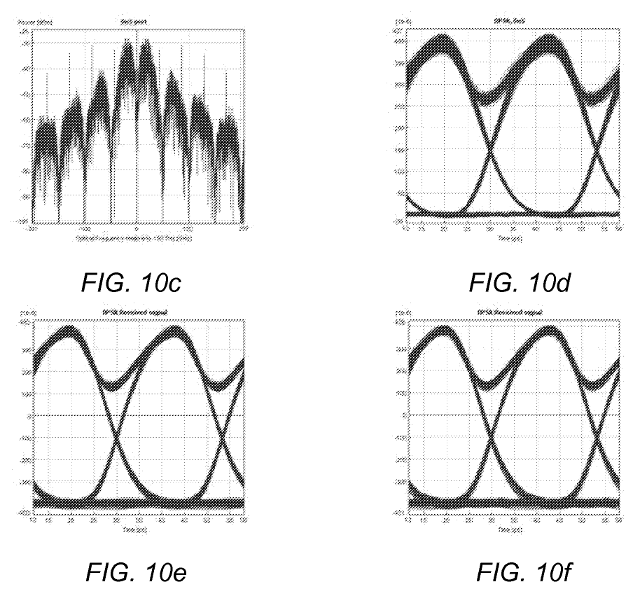

In order to achieve colorless demodulation of a DPSK signal at an ITU grid wavelength, the optical delay in the MZDI was set to 20 ps, which corresponds to an FSR of 50 GHz. FIGS. 10a and 10b depict the optical spectrum and eye diagram of the output signal from the constructive ports of the MZDI. FIGS. 10c and 10d show the optical spectrum and eye diagram of the output signal from the destructive port of the MZDI. When the central frequency of the laser was set to 193.0 THz and 193.1 THz, the corresponding eye diagrams that resulted are shown in FIGS. 9e and 9f, respectively.

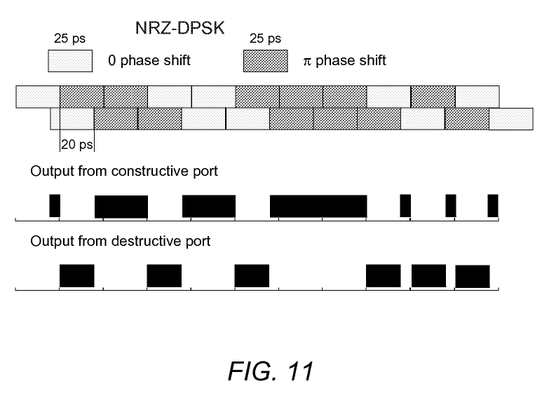

With a 20 ps delay, the pulse width of the output signal from the constructive port is broader than the signal through the one-bit-delay MZDI, as evidenced by reference to FIG. 10b as compared to FIG. 8e. With a 20 ps-delay MZDI, the pulse width of the output signal from destructive port is narrower than the signal through one-bit-delay MZDI, which is shown by reference to FIG. 10d as compared to FIG. 8g. The reasons are apparent with reference to FIG. 11, which depicts the operating principle for ˜40 Gb/s NRZ-DPSK signal demodulation using a MZDI with a FSR of 50 GHz. Due to the non-maximal signal overlap for interference, part of the signal (T−20 ps, where T is the bit period) always leaks out at the constructive port of the MZDI, while only part of the signal (20 ps out of T) can interfere with the neighboring bit. As a result, the crossing point of the received DPSK signal using a 20 ps-delay MZDI is below the zero power level, instead of crossing the zero power level. This is apparent when comparing FIG. 8h with FIG. 10e. However, these effects do not necessarily cause a penalty in the system bit error rate (BER). This demonstrates that a 20 ps-delay MZDI can be used for colorless 43 Gb/s DPSK signal demodulation for the ITU grid.

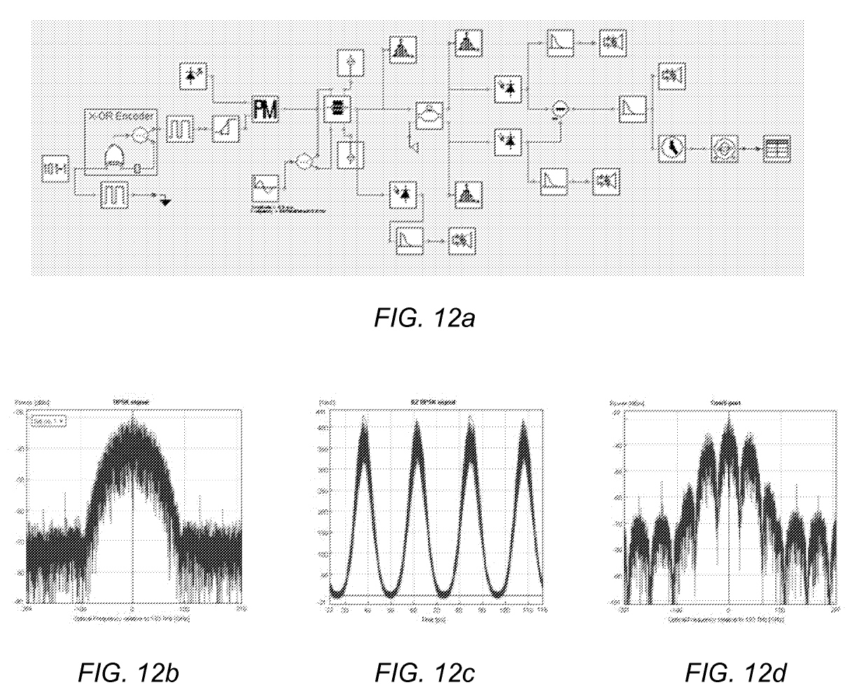

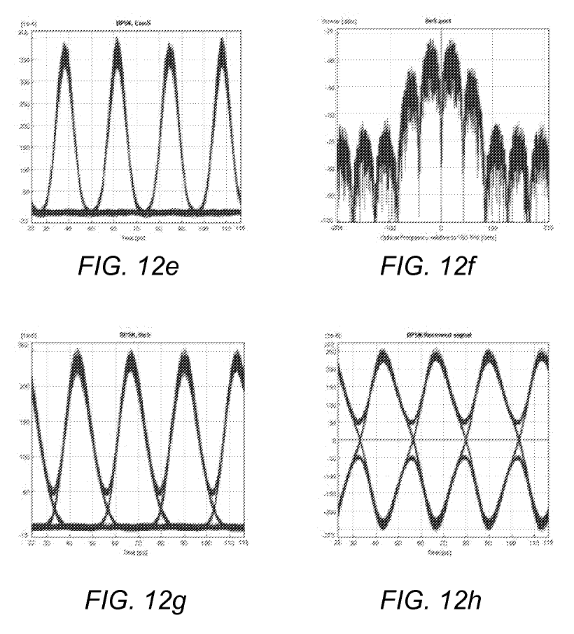

FIG. 12a is a single channel RZ-DPSK VPI simulation with a one-bit-delay MZDI as the demodulator. In this simulation, a pulse carver was added, and was achieved by driving a dual-port modulator with a half clock to operate in a push-pull mode. The central frequency of the laser is again set to 193.0 THz. The bit rate of the input signal is 43 Gb/s, and the corresponding one-bit-delay for the MZDI is 23.2591 ps. The optical spectrum and oscilloscope traces of the modulated RZ-DPSK signal are shown in FIGS. 12b and 12c, respectively. The optical spectrum of the output signal from the constructive port of the MZDI is depicted in FIG. 12d and a corresponding eye diagram is shown in FIG. 12e. The optical spectrum of the output signal from the destructive port of the MZDI is shown in FIG. 12f and the corresponding eye diagram is depicted in FIG. 12g. As can be seen with reference to FIG. 12c, the duty cycle of the generated DPSK signal is about 33%. The received signal after balanced detection is depicted in FIG. 12h.

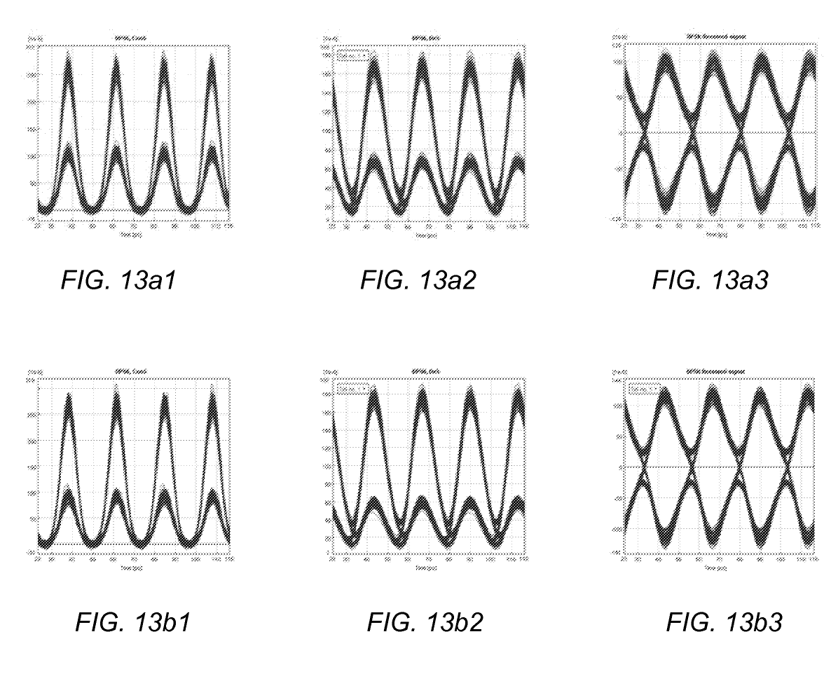

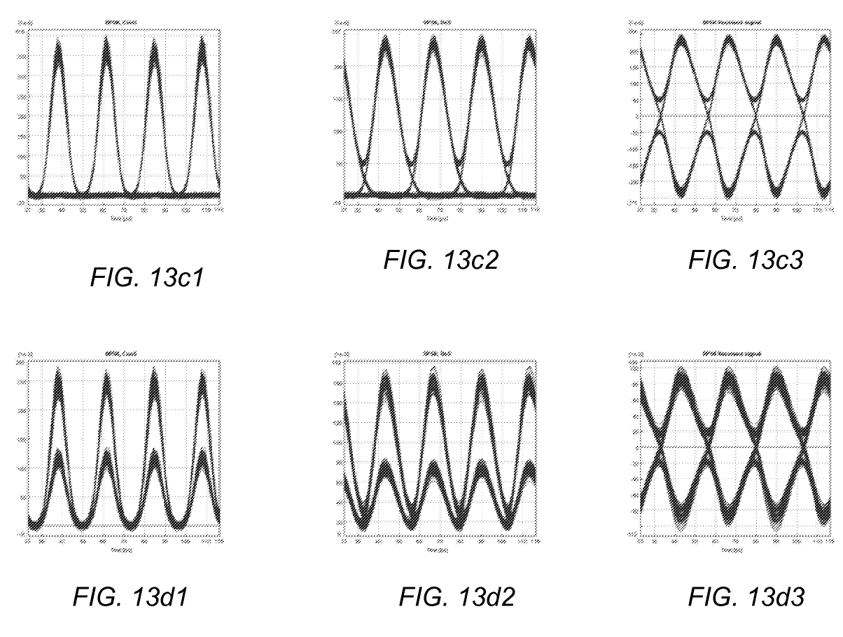

When the optical delay of MZDI is maintained at 23.2591 ps and the central frequency of the laser is changed, the inventors observed demodulated DPSK signals shown as shown in FIGS. 13a-13d. FIGS. 13a1, 13a2 and 13a3 are eye diagrams for the constructive port output, destructive port output, and balanced detection output, respectively, when the central frequency of the laser is set to 192.9 THz. FIGS. 13b1, 13b2 and 13b3 are same diagrams when the central frequency of the laser is set to 193.1 THz. FIGS. 13c1, 13c2 and 13c3 are the same diagrams when the central frequency of the laser is set to 193.3 THz. FIGS. 13d1, 13d2 and 13d3 are the same diagrams when the central frequency of the laser is set to 193.4 THz. As evidenced by FIGS. 12a3, 12b3, 12c3 and 12d3, all the eyes of the received DPSK signals at different wavelengths are clearly open, but they have different Q factor values. This difference in Q values is primarily caused by the power variations of the received DPSK signals. When the central frequency of the laser is changed to another wavelength, the interference at the MZDI becomes non-optimal. Therefore, the extinction ratio of the signals from the constructive port and destructive ports of the MZDI will decrease, as shown in FIGS. 13a-13d. With balanced detection, the problem of extinction ratio reduction can be solved, shown by the opening “eyes” in FIGS. 13a3, 13b3, 13c3 and 13d3. However, the power of the received DPSK signal may dramatically reduced, which causes the reduction of Q values, which is evident when comparing the vertical scale of FIGS. 13a3, 13b3, 13c3 and 13d3. It is also possible that optimal interference occurs at another wavelength, as shown in FIG. 13c. In practical applications, it is preferred to have equalized performance at different WDM channels.

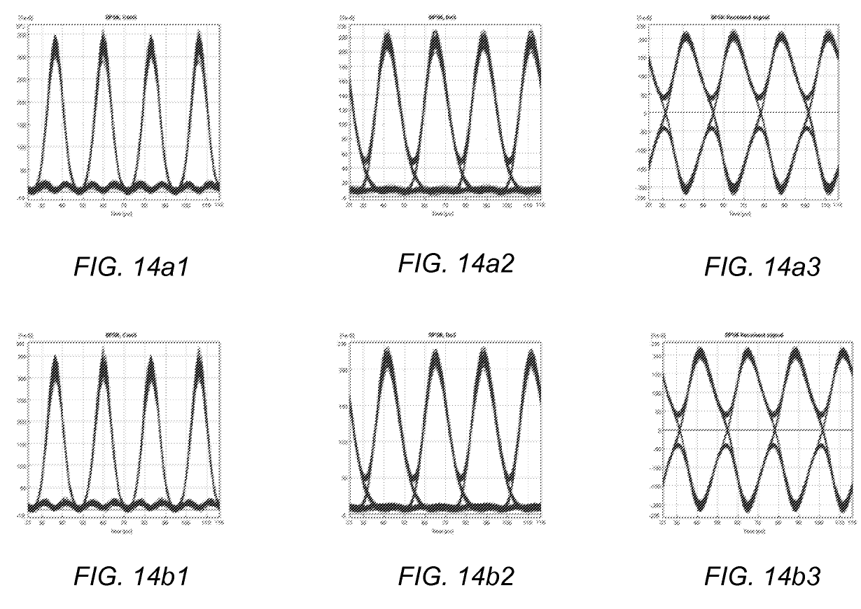

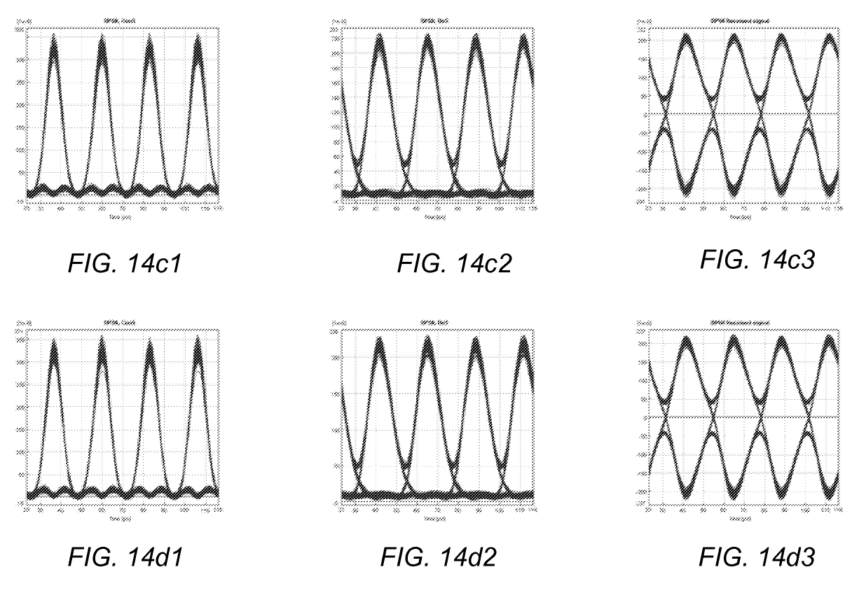

The fixed one-bit-delay MZDI has been shown to cause optical power fluctuations for RZ-DPSK signals at different ITU wavelengths. When the optical delay in the MZDI is set to 20 ps, the output signal at different ITU grids was simulated, and the results are depicted in FIGS. 14a-14d, which depict the eye diagrams for the constructive port output (FIGS. 14a1, 14b1, 14c1 and 14d1), destructive port output (FIGS. 14a2, 14b2, 14c2 and 14d2), and balanced port output (FIGS. 14a3, 14b3, 14c3 and 14d3) at different central laser frequencies similar to that shown in FIGS. 13a-13d. As can be seen, the received DPSK signals at ITU grids corresponding to 192.9 THz, 193.0 THz, 193.3 THz and 193.4 THz have almost equalized optical power and similar Q values. When looking at the demodulated signals from constructive and destructive ports of the MZDI, the 20 ps-delay MZDI causes similar power leakage for “0”s for signals at different ITU grids. With balanced detection, the power leakage due to non-maximal overlap of adjacent bits can be eliminated.

A performance analysis simulation reduced the transmitter power to maintain Q factor values merely above the requirements for a system BER of 10⁻¹². For intensity modulation and direct detection (IM/DD) optical systems, a fairly accurate BER can be calculated using the relationship:

$$BER = \frac{1}{2} erfc ( \frac{Q}{\sqrt{2}} ) \qquad ( 4 )$$

where erfc( ) is the error function. The BER improves as Q increases and becomes lower than 10⁻¹² for Q values larger than 7. For DPSK signals, there will be relatively large errors when directly using equation (4) and the Q factor from eye diagram measurements. To obtain an accurate BER, the Q factor in equation (4) could be 2-3 dB larger. Therefore, in the simulation, the inventors used a Q factor around 14.

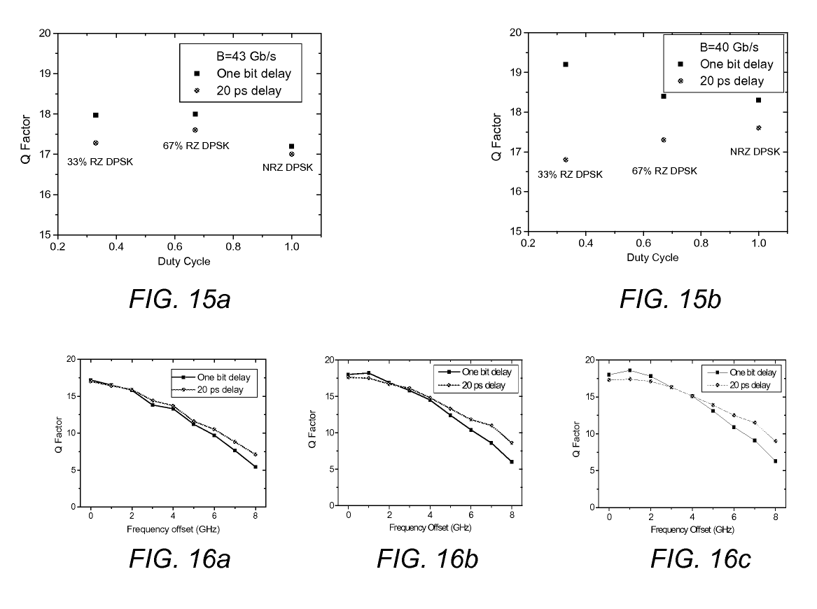

FIG. 15a is a depiction of a Q factor comparison for received DPSK signals using a MZDI with one-bit-delay or 20 ps delay at B=43 Gb/s. FIG. 15b is the same depiction using B=40 Gb/s. With the reduction of the duty cycle of DPSK signals, the Q factor reduction with a 20 ps delay MZDI will increase. When the bit rate is 43 Gb/s, the difference between the one-bit-delay and 20 ps delay is about 14%, and there is only about 0.2 dB penalty for a 33% RZ-DPSK signal. For 40 Gb/s, the difference between the one bit and 20 ps delay is 20%, and the Q factor penalty increases to 0.6 dB for the 33% RZ-DPSK signal. For a 67% RZ-DPSK signal, which is more popular for practical applications, the Q factor penalty is much smaller.

FIGS. 16a, 16b and 16c show the Q factors for received DPSK signals—NRZ-DPSK, 67% RZ-DPSK and 33% RZ-DPSK, respectively, when the laser frequency is offset from the ideal value (193 THZ) set by the MZDI with a one-bit-delay of 23.2591 ps. With an increase in laser frequency offset, the Q factor decreases. In order to keep the Q factor penalty to be within 1 dB, the laser frequency offset should be approximately within 3 GHz. As will be appreciated by those skilled in the art, a MZDI with a 20 ps delay has better tolerance to frequency offsets when compared to a MZDI with a one-bit-delay. This is due to the broader bandwidth for an MZDI with a smaller optical delay or larger FSR.

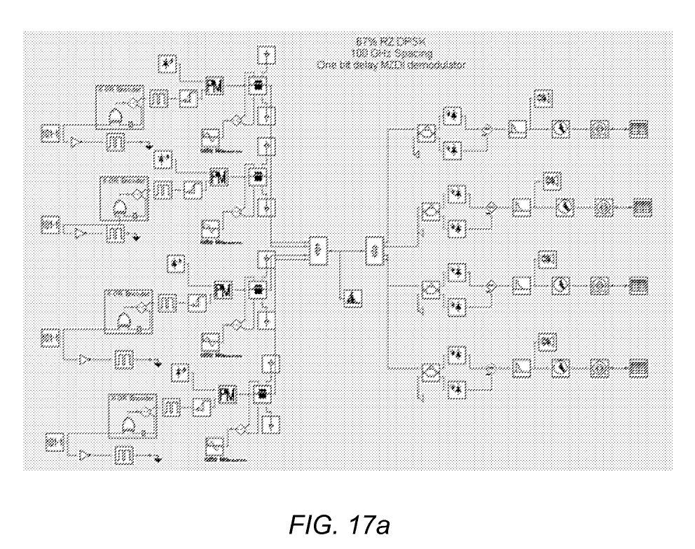

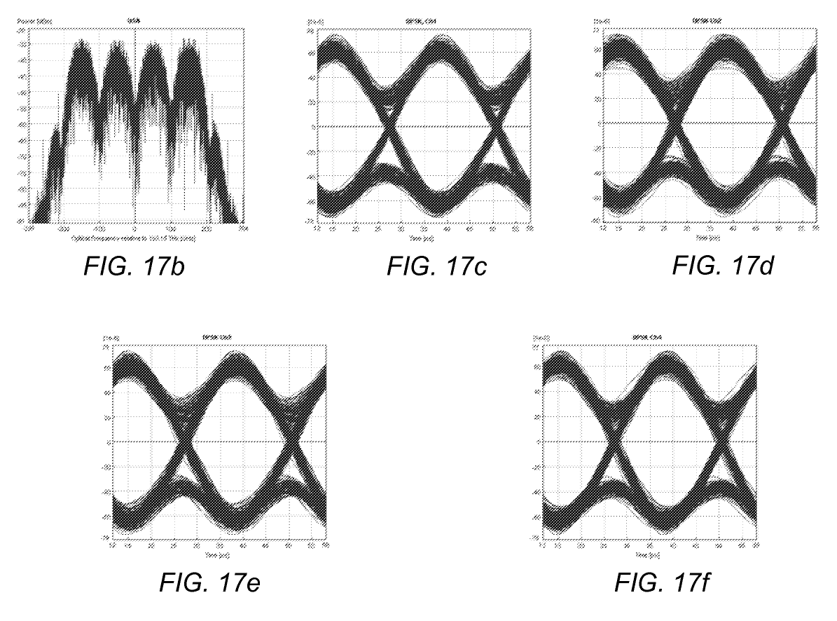

Based on the system architectures depicted in FIGS. 4 and 7, simulations using VPI transmission maker were performed utilizing a one-bit-delay and 20 ps delay MZDI demodulator, respectively. FIGS. 17a-17f depict a simulation employing a one-bit-delay MZDI. The simulation employed a bit rate B=43 Gb/s. The channel spacing for the system is 100 GHz, and the RZ-DPSK signal has a duty cycle of 67%. A filter bandwidth (3 dB) of 86 GHz was employed. Channel 1 has an ITU grid corresponding to 193.0 THz, a delay of 23.2487 ps, channel 2 an ITU grid corresponding to 193.1 THz, delay of 23.2522 ps, channel 3 an ITU grid corresponding to 193.2 THz, delay of 23.505 ps and channel 4 and ITU grid corresponding to 193.3 THz, delay of 23.2540 ps. FIG. 17b depicts the optical spectrum of the multiplexed DPSK-WDM channels. At the receiver end, the WDM channels are demultiplexed, and then demodulated with separate MZDIs (see FIG. 4). Each of the MZDIs is precisely adjusted for a specific wavelength. FIGS. 17c-17f show the eye diagrams of the received signals corresponding to channels 1-4 with Q values of 14.6, 13.7, 13.6 and 15.1, respectively. When comparing these Q factors, it can be seen that channels 2 and 3 have smaller Q factors due to crosstalk from neighboring channels.

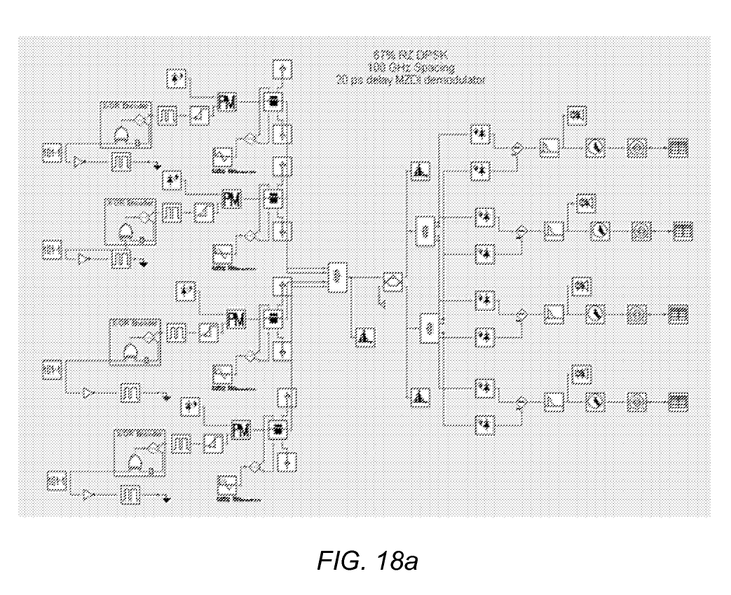

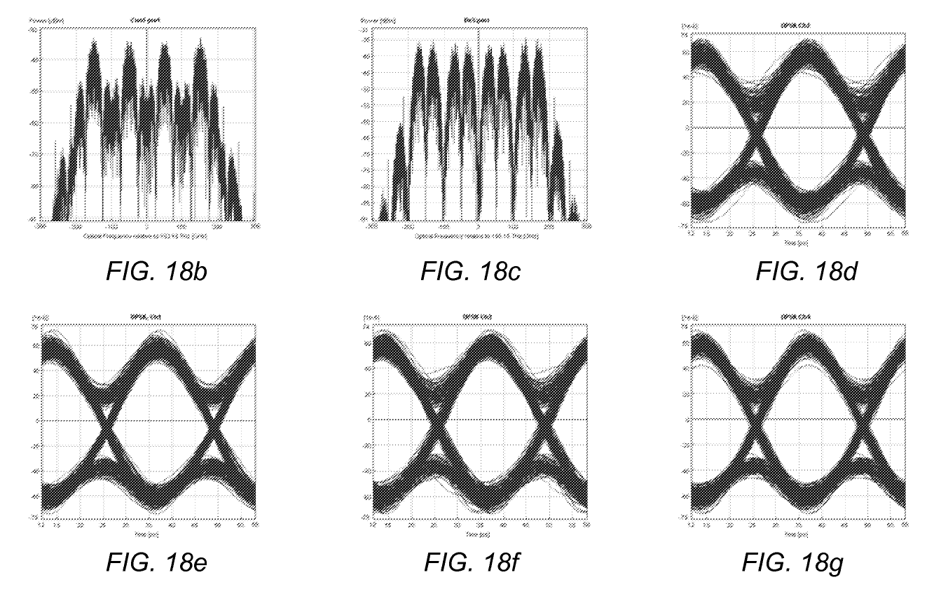

FIGS. 18a-18g depict a simulation using a colorless MZDI with a 20 ps delay to simultaneously demodulate all the DPSK-WDM channels on 100 GHz spacing ITU grids. FIGS. 18b and 18c are optical spectra of the signals from the constructive and destructive ports, respectively, of the MZDI. FIGS. 18d-18g are eye diagrams of the received signals corresponding to channels 1-4 with Q values of 13.4, 12.2, 12.4 and 14.1, respectively. The following table depicts the Q factor comparison for the 4 channels using a one-bit delay vs. a colorless MZDI with a 20 ps delay:

| | Single channel | | WDM channels | |
|---|---|---|---|---|
| Channel # | One-bit delay | Colorless | One-bit-delay | Colorless |
| 1 | 16.5 | 16.0 | 14.6 | 13.4 |
| 2 | 15.9 | 16.0 | 13.7 | 12.2 |
| 3 | 16.4 | 16.3 | 13.6 | 12.4 |
| 4 | 16.7 | 16.1 | 15.1 | 14.1 |

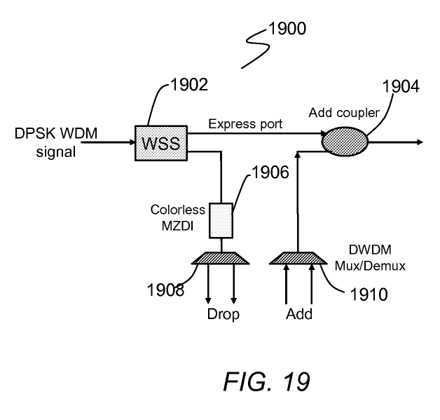

FIG. 19 is a schematic of a reconfigurable add-drop multiplexer (ROADM) 1900 using a colorless MZDI in accordance with an aspect of the invention. A DPSK-WDM signal is applied to wavelength selective switch (WSS) 1902, which can dynamically drop selected WDM channels. An express port of the WSS 1902 is coupled to an input port of an add coupler 1904, and the drop port is coupled to the input port of a colorless MZDI 1906. The MZDI 1906 can demodulate any dropped wavelength on 100 GHz spacing ITU grids. Depending on the number of drop ports, the MZDI 1906 can be disposed either before or after a WDMUX 1908. A DMUX 1910 multiplexes a plurality of input signals and couples the Multiplexed signal to another input port of add coupler 1904.

In accordance with another aspect of the invention, the crosstalk between neighboring channels in a WDM system can be reduced by using a DPSK demodulator having a FSR of ˜44.44 GHz or optical delay of ˜22.5 ps. For noise-free DPSK signal input, For noise-free DPSK signal input, the transmission at the constructive and destructive ports of a MZDI can Be expressed as:

$$\begin{matrix}{T}_{ConS} = \frac{1}{2} ( 1 + cos ( 2 π f ( D + d ) + Δ φ ) ) & ( 5 ) \\ {T}_{DeS} = \frac{1}{2} ( 1 - cos ( 2 π f ( D + d ) + Δ φ ) ) & ( 6 )\end{matrix}$$

where f is the light frequency,

$$D = \frac{1}{B} , D >> d ,$$

B is the bit repetition rate of the input signal, Δφ=0, π is the phase difference of the neighboring bit.

$$\frac{1}{D + d}$$

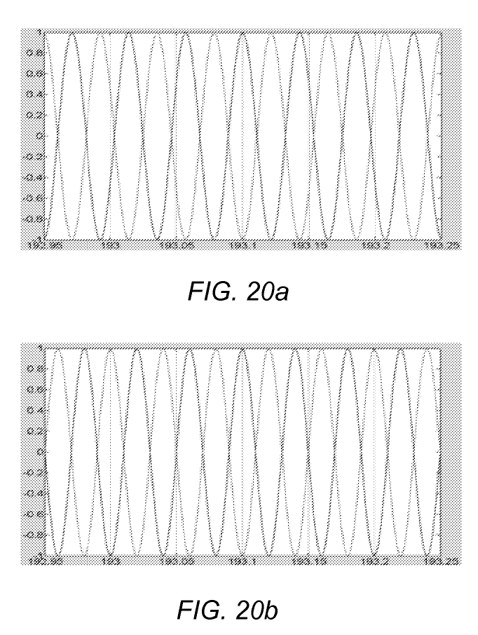

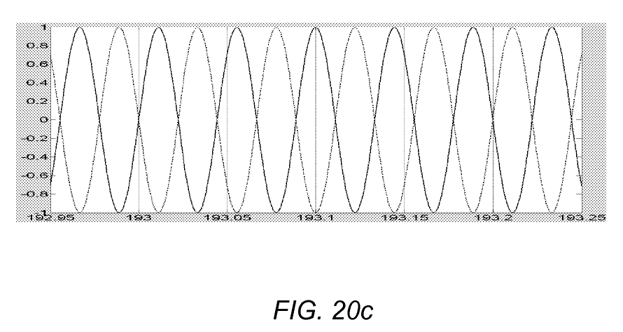

is also known as the free spectral D+d range (FSR) of the MZDI. After balanced detection, the transmission coefficient for the received signal is
T=cos(2πf(D+d)+Δφ) (7)
In the case of one-bit-delay, D+d≈B, FIGS. 20a and 20b show the transmission curves for a one-bit-delay MZDI with balanced detection when B=43 Gb/s and B=40 Gb/s, respectively. (Note that 42.7 Gb/s is the data rate for OC-768 transmission with the use of forward error correction ITU-T G.709 FEC). The solid line depicts the transmission curve for Δφ=0, and the dotted line shows the transmission curve for Δφ=π. In FIGS. 20a and 20b, the MZDI is optimized for an optical DPSK signal with central frequency of 193.1 THz, and the signal at 193.1 THz has the maximal transmission. Here the ITU grids have 100 GHz channel spacing. The neighboring channels at 193.0 THz and 193.2 THz have a reduced transmission in FIG. 20a, which is caused by non-optimal interference conditions. In FIG. 20b, the neighboring channels at 193.0 THz and 193.2 THz still have maximal transmission except that the data pattern is inverted. From FIG. 20a, it will be appreciated by those skilled in the art that a DPSK demodulator can be used to further reduce the channel crosstalk by placing the neighboring channels at non-optimal interference positions. As a comparison, the channel crosstalk in FIG. 20b is not reduced by the MZDI.

In order to further reduce the crosstalk from neighboring channels, as evidenced by FIGS. 20a and 20b, that the neighboring channels can be set at the zero transmission point when 100 GHz spacing covers two (or any positive integer as a general case) and a quarter times of the FSR. In this regard, the FSR should be very close to the data bit rate to reduce the power penalty caused by non-maximal overlap of neighboring bits. Therefore, in order to reduce the crosstalk from neighboring channels, the MZDI should have FSR of ˜44.44 GHz or optical delay of ˜22.5 ps. FIG. 20c shows the transmission curve of a low crosstalk MZDI with balanced detection. The central frequency of the DPSK signal is 193.1 THz, and the optical delay is 22.5013 ps. DPSK signals at 193.1 THz have maximal transmission while the neighboring channels at 193.0 THz and 193.2 THz have transmission coefficient of 0. The solid line depicts the transmission curve for Δφ=0, and the dotted line shows the transmission curve for Δφ=π.

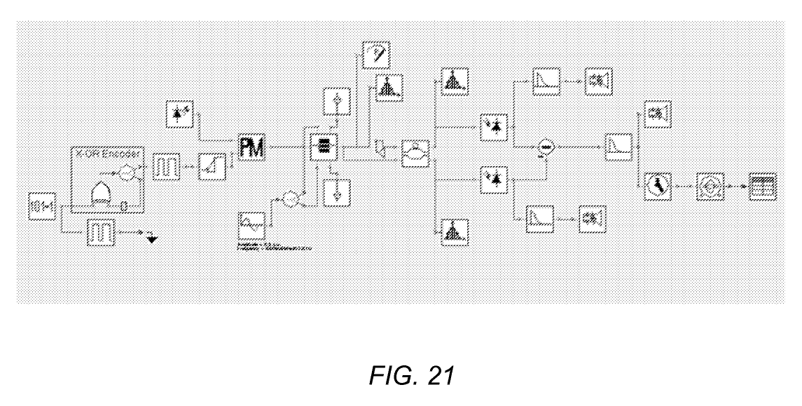

FIG. 21 is a schematic of a VPI simulation for a single channel DPSK system. The DPSK signal is generated by phase modulation followed by a Mach-Zehnder modulator-based pulse carver. The generated RZ-DPSK signal has a duty cycle of 67%, which is employed for many experimental demonstrations. The central frequency of the laser is 193.1 THz, and the optical power before MZDI is −5.8 dBm. The bandwidth of the low pass filter is twice the data rate except the one indicated at 0.7*B.

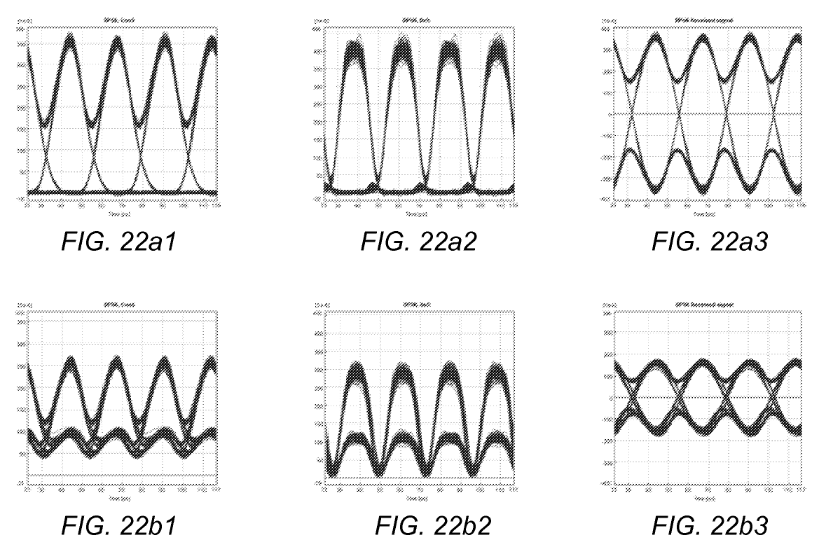

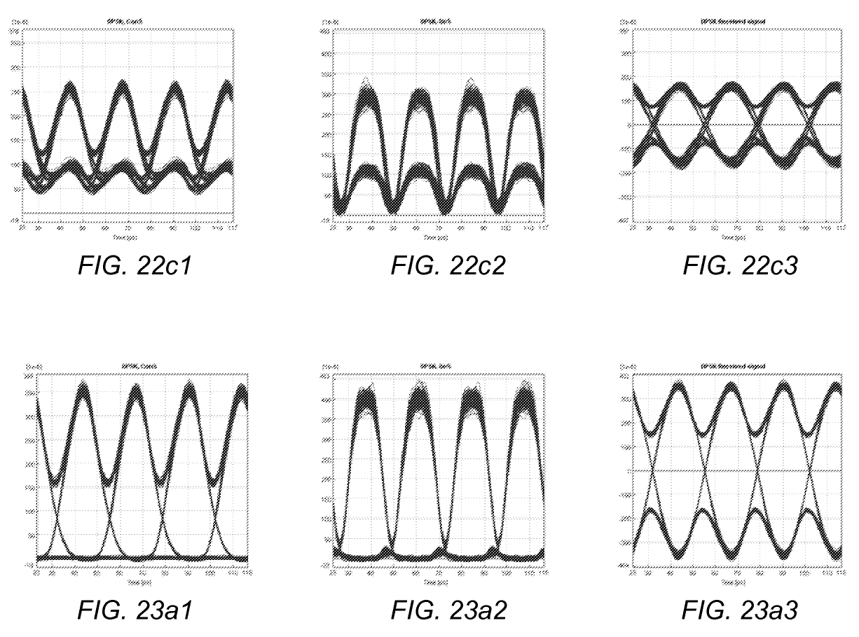

FIGS. 22a1-22c3 are eye diagrams of output signals using a one-bit-delay MZDI with B=43 GB/s and an optical delay of 23.2522 ps (optimized for 193.1 THz). FIGS. 22a1, 22a2 and 22a3 are eye diagrams for the constructive port output, destructive port output, and balanced detection output, respectively, when the central frequency of the laser is set to 193.1. FIGS. 22b1, 22b2 and 22b3 are same diagrams when the central frequency of the laser is set to 193.0. FIGS. 22c1, 22c2 and 22c3 are the same diagrams when the central frequency of the laser is set to 193.2.

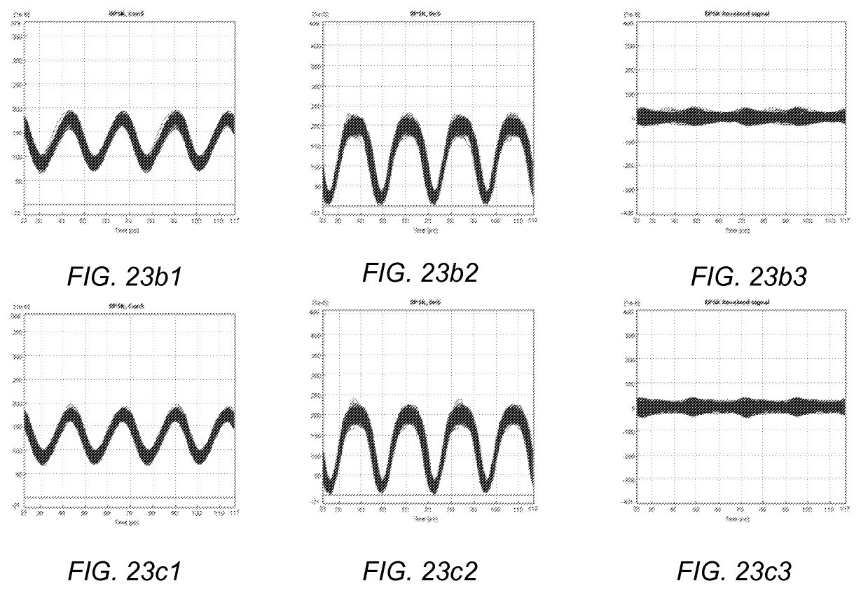

FIGS. 23a1-23c3 are eye diagrams of output signals using a low crosstalk MZDI with B=43 GB/s and an optical delay of 23.5013 ps (optimized for 193.1 THz). FIGS. 23a1, 23a2 and 23a3 are eye diagrams for the constructive port output, destructive port output, and balanced detection output, respectively, when the central frequency of the laser is set to 193.1. FIGS. 23b 1, 23b2 and 23b3 are same diagrams when the central frequency of the laser is set to 193.0. FIGS. 23c1, 23c2 and 23c3 are the same diagrams when the central frequency of the laser is set to 193.2.

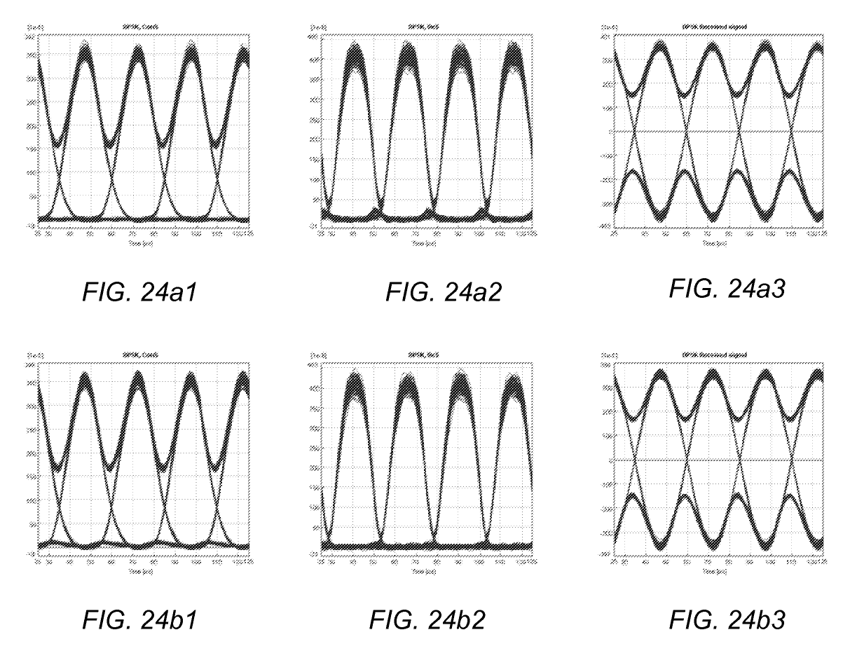

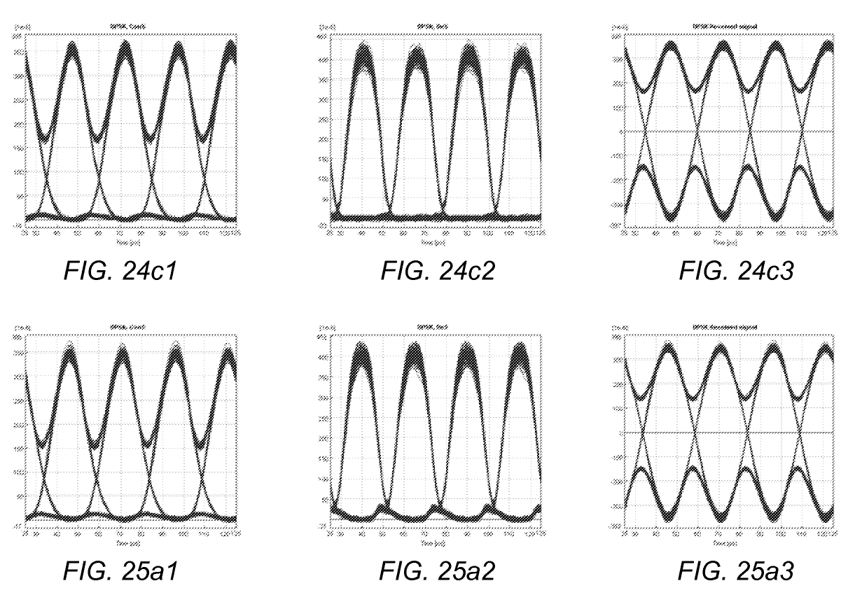

FIGS. 24a1-24c3 are eye diagrams of output signals using a one-bit-delay MZDI with B=40 GB/s and an optical delay of 25.0026 ps (optimized for 193.1 THz). FIGS. 24a1, 24a2 and 24a3 are eye diagrams for the constructive port output, destructive port output, and balanced detection output, respectively, when the central frequency of the laser is set to 193.1. FIGS. 24b1, 24b2 and 24b3 are same diagrams when the central frequency of the laser is set to 193.0. FIGS. 24c1, 24c2 and 24c3 are the same diagrams when the central frequency of the laser is set to 193.2.

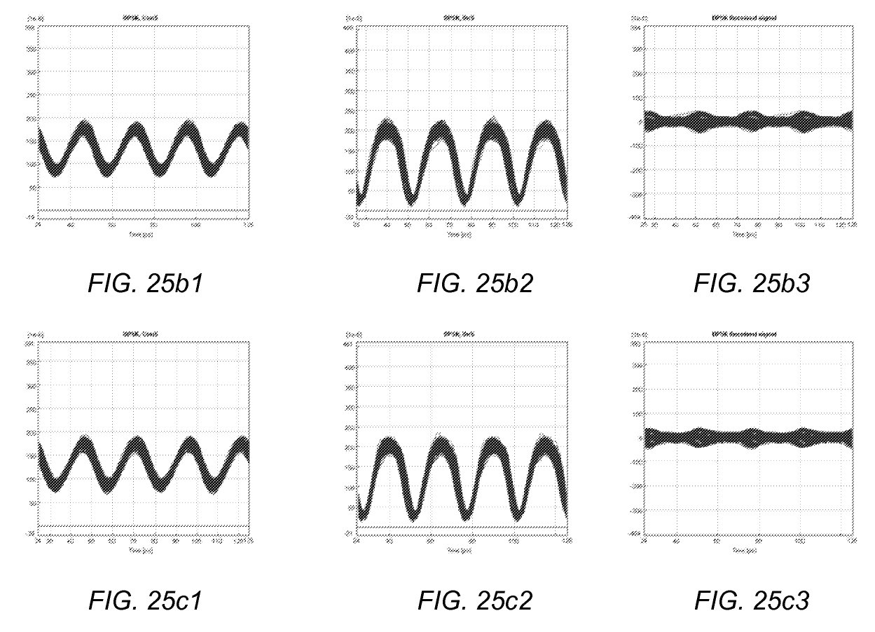

FIGS. 25a1-25c3 are eye diagrams of output signals using a low crosstalk MZDI with B=40 GB/s and an optical delay of 22.5013 ps (optimized for 193.1 THz). FIGS. 25a1, 25a2 and 25a3 are eye diagrams for the constructive port output, destructive port output, and balanced detection output, respectively, when the central frequency of the laser is set to 193.1. FIGS. 25b1, 25b2 and 25b3 are same diagrams when the central frequency of the laser is set to 193.0. FIGS. 25c1, 25c2 and 25c3 are the same diagrams when the central frequency of the laser is set to 193.2.

With reference to FIGS. 22a1-c3, the bit rate is 43 Gb/s, and the optical delay is 23.2522 ps which is one-bit-delay optimized for 193.1 THz. When the central frequency of the input signal is changed to 193.0 THz or 193.2 THz and the optical delay is fixed at 23.2522 ps, the extinction ratio of the signals from the constructive and destructive ports of the MZDI degrades dramatically due to non-optimal interference, which results in a reduction in power of the output signal as evidenced by FIGS. 22b3 and 22c3. When the optical delay of MZDI is changed to 22.5013 ps (for 193.1 THz), the power of the output signals at the neighboring channels (193.0 THz and 193.2 THz) is further reduced, as shown in FIGS. 23b3 and 23c3.

With reference to FIGS. 24a1-24c3, the signal bit rate is changed to be 40 Gb/s, and the optical delay is 25.0026 ps, which is a one-bit-delay optimized for 193.1 THz. With a fixed optical delay of 25.0026 ps, the signals of the neighboring channels of 193.0 THz and 193.2 THz also have a maximal transmission with an inverted data pattern. When the optical delay is changed to 22.5013 ps, the DPSK signal at 193.1 THz can has maximal transmission while the signals from neighboring channels (193.0 THz and 193.2 THz) have minimal transmission, as shown in FIGS. 25a1-25c3.

The simulation results depicted in FIGS. 22-25 confirm the theoretical analysis for a low crosstalk MZDI as described above, and demonstrates the potential of using MZDIs with a 22.5 ps delay as low crosstalk demodulators for ˜40 Gb/s DPSK WDM systems.

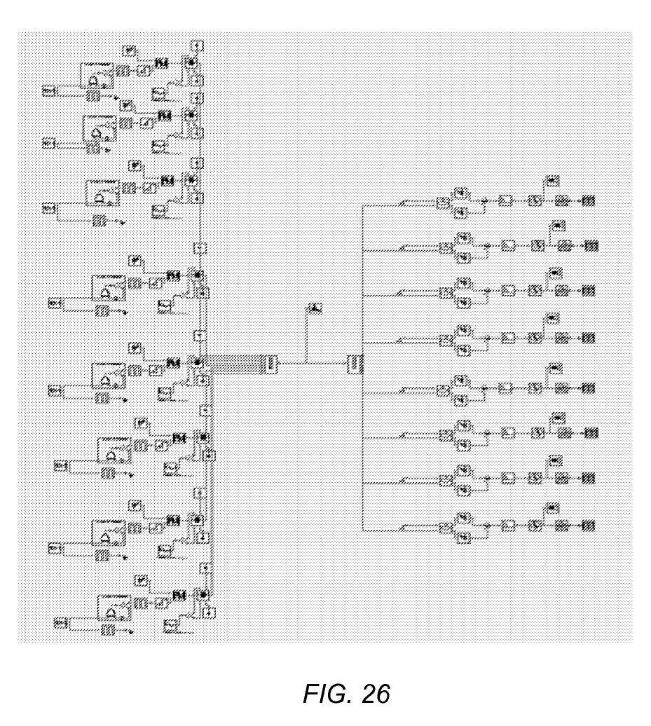

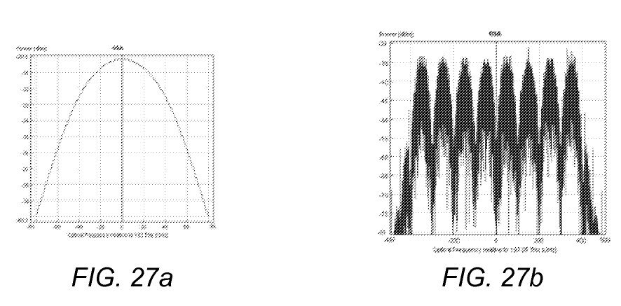

When MZDIs are used for DPSK WDM systems, the optical delay has to be precisely tuned for signals at different wavelengths. The wavelength dependent operation requires a separate MZDI for each WDM channel, as depicted in FIG. 4 and described above. The VPI simulation setup for an illustrative DPSK-WDM system is depicted in FIG. 26. There are eight channels with wavelengths from 193.0 THz to 193.7 THz at 100 GHz spacing. Each of the channels has RZ-DPSK format with a duty cycle of 67%. For each channel, the optical power before the MZDI is about −12 dBm. Each port of the WDM multiplexer and demultiplexer has a Bessel filtering shape. The transmission curve of one WDM demultiplexer port is shown in FIG. 27a. The optical spectrum of the multiplexed WDM signals is shown in FIG. 27b.

For each channel, the optical delay of the MZDI is calculated for optimal interface operation. The following table shows the Q value of optical delay used in the simulation for one-bit-delay interference or 22.5 ps-delay interference (for low crosstalk) with a B=40 Gb/s

B = 40 Gb/s

| | | One-bit- | | | |
|---|---|---|---|---|---|
| Channel | Channel | delay | Q factor | Low crosstalk | Q factor |
| Number | Frequency | (˜25 ps) | (˜25 ps) | (˜22.5 ps) | (˜22.5 ps) |
| 1 | 193.0 THz | 25 ps | 17.4 | 22.5026 ps | 17.0 |
| 2 | 193.1 THz | 25.0026 ps | 16.8 | 22.5013 ps | 16.5 |
| 3 | 193.2 THz | 25 ps | 17.9 | 22.5 ps | 17.3 |
| 4 | 193.3 THz | 25.0026 ps | 19.4 | 22.4987 ps | 19.1 |
| 5 | 193.4 THz | 25 ps | 16.7 | 22.5026 ps | 16.7 |
| 6 | 193.5 THz | 25.0026 ps | 18.3 | 22.5013 ps | 18.0 |
| 7 | 193.6 THz | 25 ps | 17.5 | 22.5 ps | 17.0 |
| 8 | 193.7 THz | 25.0026 ps | 17.9 | 22.4987 ps | 17.5 |

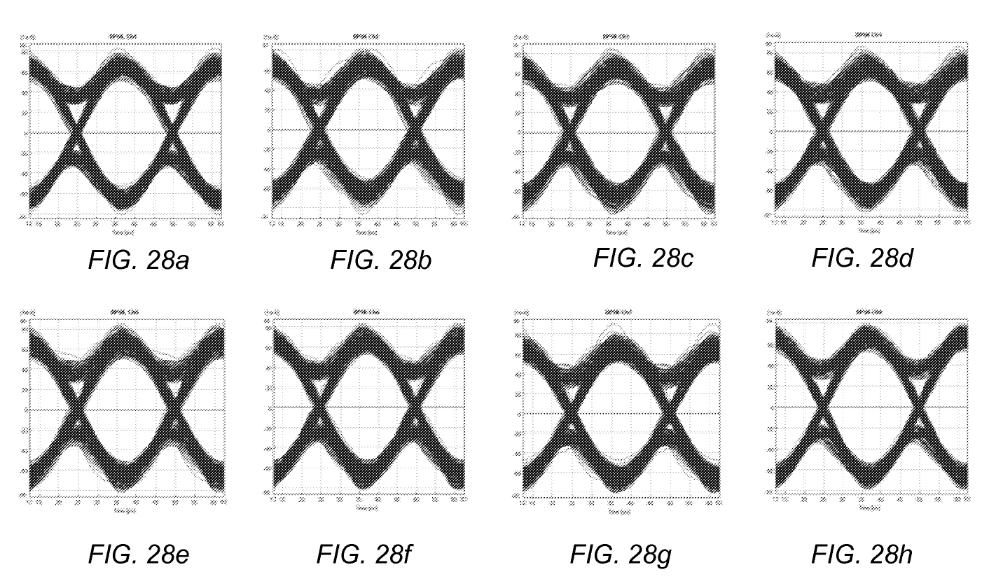

As compared with the one-bit-delay MZDI, the use of a ˜22.5 ps delay causes some minor Q factor penalty, which is mainly due to the non-maximal overlap of two neighboring bits. With a one-bit-delay MZDI as the DPSK demodulator, the eye diagrams of the received signals are shown in FIGS. 28a-28h for channels 1-8 with Q factors of 13.3, 11.3, 11.2, 11.4, 11.2, 11.5, 10.9 and 13.5, respectively. In the simulation, the filter for the WDM multiplexer and demultiplexer has a 3 dB bandwidth of 90 GHz and the channel crosstalk is about −15 dB. Here a relatively large value of channel crosstalk was employed to show the function of the low crosstalk DPSK demodulator in accordance with the invention.

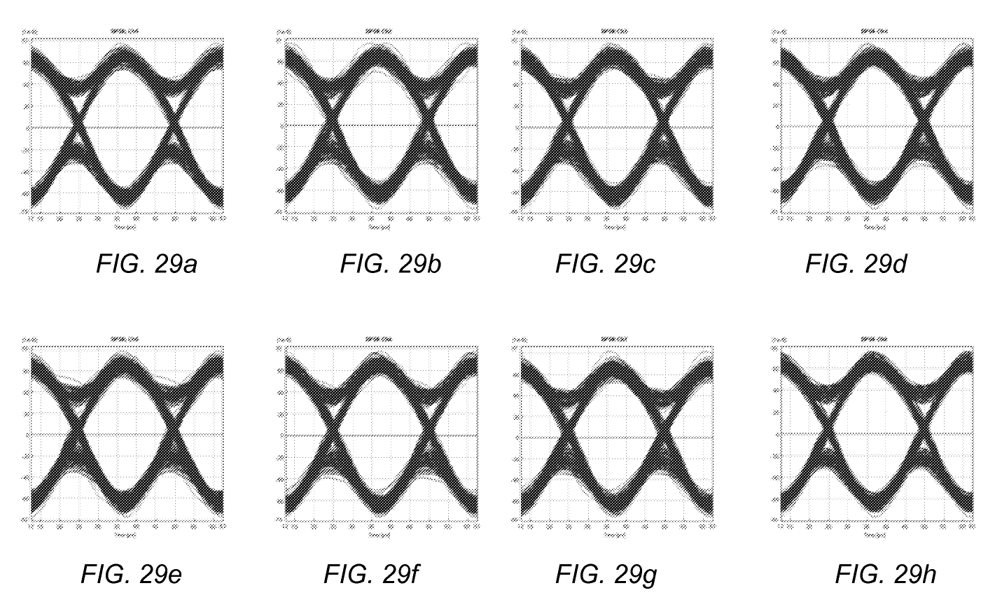

FIGS. 29a-29h are eye diagrams and Q factors of the WDM signals when the optical delay of MZDI is changed to ˜22.5 ps in accordance with an aspect of the invention. Here channels 1-8 have Q factors of 16.9, 15.1, 15.3, 15.5, 14.7, 16.2, 15.1 and 16.3, respectively. Comparing these Q factors with the one-bit-delay MZDI, it will be appreciated by those skilled in the art that a marked improvement in signal-to-noise ratio is achieved with a MZDI having a ˜22.5 ps delay.

When the bit rate=40 Gb/s, the Q factors for each WDM channel using one-bit-delay as compared to low crosstalk DPSK demodulators under different filter bandwidth are shown in the following table:

B = 40 Gb/s, Filter order 3

| | 3 dB bandwidth: | | 3 dB bandwidth: | | 3 dB bandwidth: | |
|---|---|---|---|---|---|---|
| | 70 GHz | | 80 GHz | | 90 GHz | |
| | channel crosstalk: | | channel crosstalk: | | channel crosstalk: | |
| | −19 dB | | −17 dB | | −15 dB | |
| Freq. | ˜25 ps | ˜22.5 ps | ˜25 ps | ˜22.5 ps | ˜25 ps | ˜22.5 ps |
| (THz) | One bit | Low crosstalk | One bit | Low crosstalk | One bit | Low crosstalk |
| 193.0 | 15.6 | 16.2 | 15.4 | 16.9 | 13.3 | 16.9 |
| 193.1 | 13.5 | 14.0 | 13.6 | 15.0 | 11.3 | 15.1 |
| 193.2 | 14.7 | 15.0 | 13.9 | 15.6 | 11.2 | 15.3 |
| 193.3 | 15.0 | 15.8 | 14.2 | 16.1 | 11.4 | 15.5 |
| 193.4 | 13.9 | 14.2 | 13.5 | 14.9 | 11.2 | 14.7 |
| 193.5 | 15.6 | 16.3 | 14.6 | 16.9 | 11.5 | 16.2 |
| 193.6 | 13.9 | 14.3 | 13.3 | 15.2 | 10.9 | 15.1 |
| 193.7 | 16.1 | 16.3 | 15.7 | 16.6 | 13.5 | 16.3 |

With an increase in filter bandwidth, the channel crosstalk increases. Therefore, the Q factor of received signal using a one-bit-delay demodulator decreases. As an example, the Q factor of Channel 4 (193.3 THz) decreases from 15.0 to 14.2 and 11.2 when the filter bandwidth increases from 70 GHz to 80 GHz and 90 GHz. However, when a MZDI with a ˜22.5 ps delay is used, the Q factor may not degrade with the increase of filter bandwidth and channel crosstalk. With reference again to the foregoing table, the Q factor of Channel 4 (193.3 THz) changes from 15.8 to 16.1 and 15.5 when the filter bandwidth increases from 70 GHz to 80 GHz and 90 GHz. The MZDI with a ˜22.5 ps optical delay therefore shows very good tolerance to channel crosstalk. When the filter bandwidth increases from 70 GHz to 80 GHz, the marginal improvement of Q factors is due to the enhancing of signal spectrum with broader filters, and the low crosstalk feature of the inventive demodulator can block the power leakage from neighboring channels.

To further show the influence of channel crosstalk on received signals, we keep the filter bandwidth and use different orders of the filtering curve, as shown in the following table:

B = 40 Gb/s, Filter 3 dB bandwidth = 80 GHz

| | Filter order 3 | | Filter order 5 | | Filter order 7 | |
|---|---|---|---|---|---|---|
| | Channel crosstalk: | | Channel crosstalk: | | Channel crosstalk: | |
| | −17 dB | | −20 dB | | −23 dB | |
| Freq. | ˜25 ps | ˜22.5 ps | ˜25 ps | ˜22.5 ps | ˜25 ps | ˜22.5 ps |
| (THz) | One bit | Low crosstalk | One bit | Low crosstalk | One bit | Low crosstalk |
| 193.0 | 15.4 | 16.9 | 16.2 | 16.7 | 17.3 | 17.4 |
| 193.1 | 13.6 | 15.0 | 13.6 | 14.0 | 15.0 | 15.1 |
| 193.2 | 13.9 | 15.6 | 14.7 | 15.3 | 16.2 | 16.8 |
| 193.3 | 14.2 | 16.1 | 15.6 | 16.9 | 16.8 | 18.0 |
| 193.4 | 13.5 | 14.9 | 14.2 | 14.6 | 15.4 | 15.9 |
| 193.5 | 14.6 | 16.9 | 15.7 | 16.5 | 15.9 | 16.9 |
| 193.6 | 13.3 | 15.2 | 14.7 | 15.4 | 16.0 | 16.8 |
| 193.7 | 15.7 | 16.6 | 16.6 | 16.9 | 16.7 | 17.1 |

The filter order increases from 3 to 5 and 7, the channel crosstalk decreases from −17 dB to −20 dB and −23 dB, respectively. The Q factors increase with the decreasing of channel crosstalk.

As a further comparison, simulations were performed on eight channel 43 Gb/s DPSK-WDM systems. The Q factors of individual channels using ˜23.25 ps (one bit delay) or ˜22.5 ps (for low crosstalk) are shown in the following table:

B = 43 Gb/s

| | | One bit | Q factor | Low | |
|---|---|---|---|---|---|
| Channel | Channel | delay | (˜23.25 | crosstalk | Q factor |
| Number | Frequency | (˜23.25 ps) | ps) | (˜22.5 ps) | (˜22.5 ps) |
| 1 | 193.0 THz | 23.2487 ps | 17.7 | 22.5026 ps | 17.5 |
| 2 | 193.1 THz | 23.2574 ps | 16.7 | 22.5013 ps | 16.7 |
| 3 | 193.2 THz | 23.2609 ps | 17.4 | 22.5 ps | 17.4 |
| 4 | 193.3 THz | 23.2592 ps | 17.3 | 22.4987 ps | 17.4 |
| 5 | 193.4 THz | 23.2575 ps | 18.0 | 22.5026 ps | 17.9 |
| 6 | 193.5 THz | 23.2610 ps | 16.7 | 22.5013 ps | 16.7 |
| 7 | 193.6 THz | 23.2593 ps | 17.2 | 22.5 ps | 17.1 |
| 8 | 193.7 THz | 23.2525 Ps | 16.7 | 22.4987 ps | 16.8 |

As evident from the foregoing, the Q factors of signals using ˜22.5 ps optical delay demodulators have very small degradation.

The following table compares the Q factors of received signals using the two different optical delays under different filter bandwidths:

| | 3 dB bandwidth: | | 3 dB bandwidth: | | 3 dB bandwidth: | |
|---|---|---|---|---|---|---|
| | 70 GHz | | 80 GHz | | 90 GHz | |
| | channel | | channel | | channel | |
| | crosstalk: −19 dB | | crosstalk: −17 dB | | crosstalk: −15 dB | |
| Freq. | ˜23.25 ps | ˜22.5 ps | ˜23.25 ps | ˜22.5 ps | ˜23.25 ps | ˜22.5 ps |
| (THz) | One bit | Low crosstalk | One bit | Low crosstalk | One bit | Low crosstalk |
| 193.0 | 14.4 | 14.7 | 14.5 | 15.0 | 13.9 | 15.0 |
| 193.1 | 12.8 | 13.0 | 13.2 | 13.6 | 12.5 | 13.4 |
| 193.2 | 13.0 | 13.2 | 13.1 | 13.7 | 12.2 | 13.7 |
| 193.3 | 13.6 | 13.7 | 13.4 | 13.9 | 12.4 | 13.8 |
| 193.4 | 14.0 | 14.4 | 13.8 | 14.2 | 12.5 | 13.5 |
| 193.5 | 13.3 | 13.6 | 13.1 | 13.5 | 12.2 | 13.4 |
| 193.6 | 13.6 | 13.9 | 12.9 | 13.4 | 11.7 | 12.8 |
| 193.7 | 14.0 | 14.3 | 14.6 | 15.0 | 14.6 | 15.4 |

This table evidences that the Q factor increase with the inventive low crosstalk demodulator is also small.

While exemplary drawings and specific embodiments of the present invention have been described and illustrated, it is to be understood that that the scope of the present invention is not to be limited to the particular embodiments discussed. Thus, the embodiments shall be regarded as illustrative rather than restrictive, and it should be understood that variations may be made in those embodiments by workers skilled in the arts without departing from the scope of the present invention as set forth in the claims that follow and their structural and functional equivalents.

What is claimed is:

1. A differential phase shift keyed demodulator comprising:
an input receiving at least two different wavelength channels of differential phase shift keyed communication signals;
a delay element which is tuned to simultaneously delay the different wavelength channels so that, when delayed signals are recombined with undelayed signals, the differential phase shift keyed communication signals are converted in parallel to intensity modulated signals for the different wavelength channels.

2. The demodulator of claim 1, wherein the demodulator is implemented using an interferometer to recombine the delayed signals and the undelayed signals.

3. The demodulator of claim 2, wherein the interferometer is one of a Mach-Zehnder and a Michelson-delay interferometer.

4. The demodulator of claim 1, wherein the channels in the communication signal are arranged in accordance with wavelength division multiplexing (WDM).

5. The demodulator of claim 4, wherein the delay element is tuned to a free spectral range which is half the spacing between the WDM channels.

6. The demodulator of claim 4, wherein the grid of WDM channels has a 100 GHz spacing between channels and wherein the delay element is tuned to a 20 picosecond delay.

7. The demodulator of claim 1, wherein the delay element is not tuned to a one bit delay.

8. In a wavelength division multiplexing (WDM) optical system having a plurality of differential phase-shift keyed (DPSK) transmitters for outputting a plurality of different wavelength channels of DPSK communication signals and a wavelength multiplexer for multiplexing the different wavelength channels of DPSK communication signals:
a demodulator coupled to the wavelength multiplexer and comprising an input receiving the multiplexed wavelength channels of DPSK communication signals and a delay element which is tuned to simultaneously delay the different wavelength channels so that, when delayed signals are recombined with undelayed signals, the DPSK communication signals are converted in parallel to intensity modulated signals for the different wavelength channels;
a wavelength demultiplexer coupled to an output of the DPSK demodulator for demultiplexing the intensity modulated signals into a plurality of demultiplexed intensity modulated signals.

9. The WDM optical system of claim 8, further comprising a plurality of detectors for photodetecting the demultiplexed intensity modulated signals.

10. The WDM optical system of claim 8, further comprising a second wavelength demultiplexer, wherein the wavelength demultiplexer and second wavelength demultiplexer are respectively coupled to a constructive port and a destructive port of the DPSK demodulator.

11. The WDM optical system of claim 10, further comprising a plurality of balanced detectors for photodetecting the demultiplexed intensity modulated signals.

13. The WDM optical system of claim 8, wherein the demodulator is implemented using an interferometer to recombine the delayed signals and the undelayed signals.

14. The WDM optical system of claim 13, wherein the interferometer is one of a Mach-Zehnder and a Michelson-delay interferometer.

15. The WDM optical system of claim 8, wherein the delay element is tuned to a free spectral range which is half the spacing between the different wavelength channels.

16. The WDM optical system of claim 8, wherein the grid of WDM channels has a 100 GHz spacing between channels and wherein the delay element is tuned to a 20 picosecond delay.

17. The WDM optical system of claim 8, wherein the delay element is not tuned to a one bit delay.

18. A differential phase shift keyed demodulator comprising:
an input receiving at least two different wavelength channels of differential phase shift keyed communication signals;
a delay element which is tuned to simultaneously delay the different wavelength channels so that, when delayed signals are recombined with undelayed signals, the differential phase shift keyed communication signals are placed at non-optimal interference positions for the different wavelength channels.

19. The demodulator of claim 18, wherein the demodulator is implemented using an interferometer to recombine the delayed signals and the undelayed signals.

20. The demodulator recited in claim 19, wherein the interferometer is one of a Mach-Zehnder and a Michelson-delay interferometer.

21. The demodulator of claim 20, wherein the channels in the communication signal are arranged in accordance with wavelength division multiplexing (WDM).

22. The demodulator of claim 21, wherein the delay element is tuned to a free spectral range which is 1/2.25 the spacing between the WDM channels.

23. The demodulator of claim 21, wherein the grid of WDM channels has a 100 GHz spacing between channels and wherein the delay element is tuned to a 22.5 picosecond delay.
